(19) United States
(12) Patent Application Publication
(10) Pub. No.: US 2024/0234055 A1
(43) Pub. Date: Jul. 11, 2024

(54) HYBRID RELAY

(71) Applicants: Steve Chapel, Iliff, CO (US); William Pachoud, Boulder, CO (US)

(72) Inventors: Steve Chapel, Iliff, CO (US); William Pachoud, Boulder, CO (US)

(73) Assignee: Zonit Structured Solutions, LLC, Boulder, CO (US)

(21) Appl. No.: 18/616,002

(22) Filed: Mar. 25, 2024

Related U.S. Application Data
(63) Continuation-in-part of application No. 18/133,382, filed on Apr. 11, 2023, now Pat. No. 11,948,760.
Application No. 18/133,382 is a continuation of application No. 17/201,960, filed on Mar. 15, 2021, now Pat. No. 11,626,262.
Application No. 17/201,960 is a continuation of application No. 16/055,338, filed on Aug. 6, 2018, now Pat. No. 10,950,399.
Application No. 16/055,338 is a continuation of application No. 15/425,831, filed on Feb. 6, 2017, now Pat. No. 10,068,730.
Application No. 15/425,831 is a continuation of application No. 14/217,172, filed on Mar. 17, 2014, now Pat. No. 9,601,284.
(63) Continuation-in-part of application No. 18/062,429, filed on Dec. 6, 2022, now Pat. No. 11,949,407.
Application No. 18/062,429 is a continuation of application No. 16/889,444, filed on Jun. 1, 2020, now Pat. No. 11,522,534.
Application No. 16/889,444 is a continuation of application No. 15/706,368, filed on Sep. 15, 2017, now Pat. No. 10,673,429.
Application No. 15/706,368 is a continuation of application No. 14/217,179, filed on Mar. 17, 2014, now Pat. No. 9,793,887.
(63) Continuation-in-part of application No. 18/229,052, filed on Aug. 1, 2023.
(60) Provisional application No. 61/798,593, filed on Mar. 15, 2013.
(60) Provisional application No. 61/792,576, filed on Mar. 15, 2013.

(51) Int. Cl. H01H 29/00; H01H 9/56; H01H 57/00

(52) U.S. Cl. CPC H01H 29/004; H01H 9/56; H01H 57/00; H01H 2029/008; H01H 2057/006; H01H 2201/022

(57) ABSTRACT

A relay (1) includes a motor (20) and a primary electrical switch assembly (132).

Primary electrical switching attachment points (113) are switched by a moveable switching link (101) which is moved in and out of the switch on an switched off position axially by the motor (20) in response to electrical signals delivered to the coil (26) via the flexible leads (32, 33). The switching link (101) includes a mercury reservoir (119). A piezoelectric disk bender (105) displaces mercury to close the gaps between the attachment points (113).

### CROSS-REFERENCES

This application is a continuation-in-part of U.S. patent application Ser. No. 18/133,382, filed Apr. 11, 2023, entitled “HYBRID RELAY,” which is a continuation of U.S. patent application Ser. No. 17/201,960, filed Mar. 15, 2021, entitled “HYBRID RELAY,” which is a continuation of U.S. patent application Ser. No. 16/055,338, filed Aug. 6, 2018, entitled “HYBRID RELAY,” now U.S. Pat. No. 10,950,399, issued Mar. 16, 2021, which is a continuation of U.S. patent application Ser. No. 15/425,831, filed Feb. 6, 2017, entitled “HYBRID RELAY,” now U.S. Pat. No. 10,068,730, issued Sep. 4, 2018, which is a continuation of U.S. patent application Ser. No. 14/217,172, filed Mar. 17, 2014, entitled “HYBRID RELAY,” now U.S. Pat. No. 9,601,284, issued Mar. 21, 2017, which claims priority to U.S. Provisional Application No. 61/798,593, entitled “HYBRID RELAY,” filed Mar. 15, 2013. The contents of the above applications are incorporated herein by reference as set forth in full and priority therefrom is claimed to the full extent allowed by U.S. law.

This application is a continuation-in-part of U.S. patent application Ser. No. 18/229,052, which is entitled “ACCELERATED MOTION RELAY,” filed Aug. 1, 2023, which is a continuation of U.S. patent application Ser. No. 17/397,283 which is entitled “ACCELERATED MOTION RELAY,” filed Aug. 9, 2021, now U.S. Pat. No. 11,721,505, issued Aug. 8, 2023, which is a continuation of U.S. patent application Ser. No. 16/438,195 which is entitled “ACCELERATED MOTION RELAY,” filed Jun. 11, 2019, now U.S. Pat. No. 11,211,216, issued Dec. 28, 2021, which is a continuation of U.S. patent application Ser. No. 15/452,917 which is entitled “ACCELERATED MOTION RELAY,” filed Mar. 8, 2017, now U.S. Pat. No. 10,361,050, issued Jul. 23, 2019, which is a continuation of U.S. patent application Ser. No. 14/217,159 which is entitled “ACCELERATED MOTION RELAY,” filed Mar. 17, 2014, now U.S. Pat. No. 9,646,789, issued May 9, 2017, that application being a nonprovisional of U.S. patent Application No. 61/792,738 which is entitled “ACCELERATED MOTION RELAY,” filed Mar. 15, 2013. The contents of each of the above applications are incorporated herein by reference as set forth in full and priority from this application is claimed to the full extent allowed by U.S. law.

This application is a continuation-in-part of U.S. patent application Ser. No. 18/062,429, entitled “SOLID STATE RELAY,” filed Dec. 6, 2022, which is a continuation of U.S. patent application Ser. No. 16/889,444, entitled, “SOLID STATE RELAY,” filed Jun. 1, 2020, now U.S. Pat. No. 11,522,534, issued Dec. 6, 2022, which is a continuation of U.S. patent application Ser. No. 15/706,368, entitled, “SOLID STATE RELAY,” filed Sep. 15, 2017, now U.S. Pat. No. 10,673,429, issued Jun. 2, 2020, which is a continuation of U.S. patent application Ser. No. 14/217,179, entitled, “SOLID STATE RELAY,” filed Mar. 17, 2014, now U.S. Pat. No. 9,793,887, issued Oct. 17, 2017, which claims benefit of provisional U.S. patent Application No. 61/792,576, entitled, “SOLID STATE RELAY,” filed Mar. 15, 2013, the contents of which are incorporated herein by reference as set forth in full and priority from this application is claimed to the full extent allowed by U.S. law.

The following applications are incorporated by reference herein, though no priority claim is made:
1) U.S. Provisional Patent Application No. 61/372,752, filed Feb. 26, 2013, entitled “HIGHLY PARALLEL REDUNDANT POWER DISTRIBUTION METHODS;”
2) U.S. patent Application Publication No. US-2012/0181869-A1, published on Jul. 19, 2012, entitled, “PARALLEL REDUNDANT POWER DISTRIBUTION,” U.S. patent application Ser. No. 13/208,333, (“the '333 Application”) filed on Aug. 11, 2011, entitled, ““PARALLEL REDUNDANT POWER DISTRIBUTION,” which is a nonprovisional of and claims priority from U.S. Provisional Patent Application No. 61/372,752, filed Aug. 11, 2010, entitled “HIGHLY PARALLEL REDUNDANT POWER DISTRIBUTION METHODS,” and U.S. Provisional Patent Application No. 61/372,756, filed Aug. 11, 2010, entitled “REDUNDANT POWER DISTRIBUTION;”
3) U.S. Pat. No. 8,004,115 from U.S. patent application Ser. No. 12/569,733, filed Sep. 29, 2009, entitled AUTOMATIC TRANSFER SWITCH MODULE, which is a continuation-in-part of U.S. Pat. No. 12/531,212, filed on Sep. 14, 2009, entitled “AUTOMATIC TRANSFER SWITCH,”, which is the U.S. National Stage of PCT Application US2008/57140, filed on Mar. 14, 2008, entitled “AUTOMATIC TRANSFER SWITCH MODULE,” which claims priority from U.S. Provisional Application No. 60/894,842, filed on Mar. 14, 2007, entitled “AUTOMATIC TRANSFER SWITCH MODULE;”
4) U.S. patent Application Publication No. US-2012-0092811 for U.S. patent application Ser. No. 13/108,824, filed on May 16, 2011, entitled, “POWER DISTRIBUTION SYSTEMS AND METHODOLOGY,” is a continuation of U.S. patent application Ser. No. 12/891,500, filed on Sep. 27, 2010, entitled, “POWER DISTRIBUTION METHODOLOGY,” which is a continuation-in-part of International Patent Application No. PCT/US2009/038427, filed on Mar. 26, 2009, entitled, “POWER DISTRIBUTION SYSTEMS AND METHODOLOGY,” which claims priority from U.S. Provisional Application No. 61/039,716, filed on Mar. 26, 2008, entitled, “POWER DISTRIBUTION METHODOLOGY;” and,
5) U.S. Pat. No. 8,374,729, from U.S. patent application Ser. No. 12/569,377, entitled, “SMART ELECTRICAL OUTLETS AND ASSOCIATED NETWORKS,” filed Sep. 29, 2009, which is a continuation of U.S. patent application Ser. No. 12/531,226, entitled, “SMART ELECTRICAL OUTLETS AND ASSOCIATED NETWORKS,” filed on Feb. 16, 2010, which is the U.S. National Stage of PCT/US2008/057150, entitled, “SMART NEMA OUTLETS AND ASSOCIATED NETWORKS,” filed on Mar. 14, 2008, which in turn claims priority to U.S. Provisional Application No. 60/894,846, entitled, “SMART NEMA OUTLETS AND ASSOCIATED NETWORKS,” filed on Mar. 14, 2007.

### FIELD

Embodiments of the present invention relate to the design and operation of a low loss mechanical relay with actuation speeds that are faster than traditional mechanical relay designs. There are many uses for such a device, we note uses of the present invention that relate generally to electrical power distribution and management and, in particular, to an electrical outlet, or other device associated with a local (e.g., single or multiple residential or business premises) circuit, to intelligently monitor at least a portion of the circuit and control delivery of electricity over the circuit. The invention also has application to the design and operation of power distribution devices, for example, manual or automatic transfer switches and, in particular, to devices used in mission critical environments such as medical contexts, the power utility grid or in data center or telecommunications environments.

### BACKGROUND

Switching mechanisms for electrical connections currently are divided into solid-state based switching devices (triacs, etc.) that switch very fast but have the disadvantage of being inefficient, losing between 1-2% of the power sent through them as heat, and mechanical based relays that switch much slower but are much more efficient with minimal heat loss. Many devices use solid state switches or mechanical relays to control electricity with the advantages and drawbacks noted above. Regardless of the type of switch, solid-state or mechanical relay, in many applications, either or both transfer time and efficiency are important, and may be critical.

One example is in intelligent power management of receptacles in the home and office, where “cycle-stealing” is used as described in “SMART ELECTRICAL OUTLETS AND ASSOCIATED NETWORKS”, referenced above. Such cycle stealing relates to operation in a reduced power mode by eliminating half cycles (or integer multiples thereof) of the delivered power signal, preferably by switching synchronized with zero crossings of the power signal. This may be done, for example, to implement intelligent brown-outs in the case of power shortages. The relay needed for the application must be fast and efficient, because it must actuate quickly and also must function in an environment (for example inside a single-gang receptacle box) where cooling is limited.

Another example is the design and management of power distribution in data centers because the power supplies used in modern Electronic Data Processing (EDP) equipment can often only tolerate very brief power interruptions. For example, the Computer and Business Equipment Manufacturers Association (CBEMA) guidelines used in power supply design recommend a maximum outage of 20 milliseconds or less. This is a very important issue in the design of automatic transfer switches (ATS), for switching between two or more power sources (e.g., due to power failures such as outages or power quality issues), as well as other power distribution devices used with EPD equipment. There are many other examples of devices incorporating electricity, where the speed and/or efficiency of the switching function is an important issue and improvements in these areas would be of great benefit.

In certain contexts, the size of a relay is also critical. Numerous products in the electronic marketplace utilize industry standard relays in small form factor packages. An example relay of such type is referred to as the G2RL footprint, among other trade names. These small form factor footprints allow compact deployment of a variety of medium power relays on Printed Circuit Boards (PCB) in a manner that is efficient in volumetric deployment and has pin spacing at or very near the practical limits to be Agency accepted. Specifically, “Agency” refers to Underwriters Laboratories, or UL, and/or any other approving agencies concerned with PCB copper trace placement and spacing. This miniature relay interconnection layout, being common within the industry is applicable to a wide variety of electro-mechanical relay combinations. In some applications, the use of Solid-State Relays (SSR) is desirable.

However, the use of SSRs in this miniature footprint has been restricted to build-as-you-go methodology, and no defined package for a SSR in this format has been developed or recognized due to a simple problem—dissipating heat. In a traditional electro-mechanical relay of this size, very little heat is generated, due to the mechanical contacts having very little resistance. Typical heat generation by-product numbers are less than a Watt when the electro-mechanical version is passing its rated power. The rated power of the example G2RL relays that are used as an example case in this invention would typically be 6 Amps at 240 Volts. In addition, these relays are often in one of three configurations. Industry references are Form A, Form B and Form C. Forms A and B are simply two contacts either connected together by activation or the relay, (Form A), two contacts either dis-connected from each other by activation or the relay, (Form B), or three contacts, one of which is a common that is disconnected from one of the other contacts and connected to the third contact when activated (Form C). Of these, certain aspects of the present invention apply to all three forms, but primarily concern the third, the Form C variety, as it is the most complex of the three varieties.

### SUMMARY

The present invention relates to improving the transfer time of relays in various contexts including power distribution and management in the home and office and in data center environments. In particular, the invention relates to providing improved transfer time for very efficient relays which can be used in wide variety of applications where one or both of fast transfer time and efficiency are important. Such relays are useful in the design of automatic transfer switches (ATS), for switching between two or more power sources (e.g., due to power failures such as outages or power quality issues), as well as other power distribution components.

The objectives of the various aspects of present invention are addressed by providing various systems, components, and processes for improving relay function. Many aspects of the invention, as discussed below, are applicable in a variety of contexts. However, the invention has advantages in connection with home and office power distribution, efficiency, and management and in data center applications. In this regard, the invention provides considerable flexibility in maximizing power distribution efficiency and designing power distribution devices that use relays for use in data center and other environments. The invention is advantageous in designing the devices used in power distribution to server farms such as are used by companies such as Google or Amazon or cloud computing providers.

Some of the objectives of a first aspect of the invention include the following:

Providing methods to improve the transfer time of relays in connection with devices that use relays, for example automatic transfer switches, such that the transfer time of the device incorporating the improved relays is reduced; and

Improving the transfer time of a highly redundant, fault-tolerant, scalable, modular parallel switch design methodology that allows a family of automatic transfer switches in needed form factors to be constructed for a variety of auto-switching needs in the data center and other environments.

These objectives and others are addressed in accordance with the present invention by providing various systems, components and processes for improving relay function. Many aspects of the invention, as discussed below, are applicable in a variety of contexts. However, the invention has particular advantages in connection with home and office power distribution, efficiency and management and in data center applications. In this regard, the invention provides considerable flexibility in maximizing power distribution efficiency and designing power distribution devices that use relays for use in data center and other environments. The invention is advantageous in designing the devices used in power distribution to server farms such as are used by companies such as Google or Amazon or cloud computing providers.

In accordance with one aspect of the present invention, a method and apparatus (“utility”) is provided for switching power using a hybrid design involving mechanical and electrically conductive liquid components. The utility involves providing first and second electrical contacts and a drive system for driving at least one of the first and second contacts for relative movement therebetween. For example, the first electrode may be mounted on a piston that reciprocates within a cylinder and the second contact may be mounted on a wall of the cylinder. The first and second contacts are moveable between first and second positions where the contacts are separated by first distance in the first position and a second distance, less than the first distance, in the second position. The utility further involves an electrically conductive liquid system for establishing an electrical contact, via a conductive liquid, between the first and second contacts in the second position. For example, the electrically conductive liquid system may include a reservoir receptacle for retaining a supply of the conductive liquid and a pump mechanism for selectively pumping the conductive liquid into a space between the first and second contacts or retracting the conductive liquid from the space. In one implementation, the pump mechanism includes a piezo-electrical disk for contracting and expanding the reservoir receptacle. The present invention thereby provides a fast response like a solid-state based switching device while also providing excellent efficiency and minimum heat generation like a mechanical relay. Consequently, the invention can be used in a variety of contexts including synchronizing switching with zero crossings of the power signal, e.g., for cycle stealing.

The present invention further relates to improving the transfer time of relays in various contexts including in data center environments. In particular, the invention relates to providing improved transfer time for relays, which can be used in the design of automatic transfer switches (ATS), for switching between two or more power sources (e.g., due to power failures such as outages or power quality issues), as well as other power distribution components. Some of the objectives of a further aspect of the present invention include the following:

Providing methods to improve the transfer time of relays in connection with devices that use relays, for example automatic transfer switches, such that the transfer time of the device incorporating the improved relays is reduced; and

Enabling the use of relays for power transfer even in connection with equipment that can only tolerate short power interruptions, thereby allowing for efficient, reliable, and scalable transfer switch designs.

Improving the transfer time of a highly redundant, fault-tolerant, scalable, modular parallel switch design methodology that allows a family of automatic transfer switches in needed form factors to be constructed for a variety of auto-switching needs in the data center and other environments.

In accordance with this aspect the present invention, a method is provided for switching electrical power using a relay. The relay includes a moveable electrode structure (e.g., an armature or any other moveable electrode device) and first and second circuit electrodes (e.g., normally open and normally closed contacts). The moveable electrode structure is moveable between a first position, where the moveable electrode structure electrically contacts the first circuit electrode to enable current flow in a first circuit (e.g., depending on the configuration of the first the circuit and state of components on that circuit), and a second position, where the moveable electrode structure electrically contacts the second circuit electrode. The inventive method involves accelerating the moveable electrode structure during a first portion of its travel path between the first and second electrodes and decelerating the moveable electrode structure during a second portion of its travel path between the first and second electrodes.

The acceleration and deceleration are preferably controlled by an electromagnetic drive system but may additionally or alternatively include mechanical elements such as springs or other mechanisms.

Such acceleration and deceleration can be employed to reduce the transfer time between the first and second circuit electrodes and/or to provide a soft landing so as to extent electrode life, reduce bounce, and allow for different material options for the electrodes. In this regard, the moveable electrode structure may be accelerated in an initial portion of the travel path and decelerated in a terminal portion of the travel path. The acceleration and deceleration can be substantially symmetric in relation to a mid-point of the path such that a maximum velocity of the moveable electrode structure occurs at or near the mid-point and velocity drops close to zero at contact landing. A corresponding relay apparatus includes an electromagnetic drive system operative to accelerate and decelerate the moveable electrode structure during transfer.

In accordance with another aspect of the present invention, a relay with bi-directional electromagnetic drive is provided. An electromagnetic drive is provided that is operative to exert a first electromagnetic force on a moveable electrode structure effective to accelerate the moveable electrode structure in a first direction relative to an axis extending between first and second circuit electrodes. The drive is further operative to accelerate the moveable electrode structure in a second direction relative to the axis.

The electromagnetic drive may include drive elements (e.g., an electromagnetic core and windings) on one side or both sides of the gap between the circuit electrodes. One or more of the drive elements may be reversible in polarity, and the drive elements may be operated at the same or different time periods. The drive elements may repel and/or attract the moveable electrode structure. The bi-directional electronic drive may be used to accelerate and decelerate the moveable electrode structure during a single transfer, to allow for bi-directional electromagnetic actuation (e.g., thus eliminating the need for springs or other components), or to allow bi-directional control for any other reason desired. A corresponding method involves operating an electromagnetic drive system to accelerate a moveable electrode structure in a first direction relative to the axis extending between the circuit electrodes and operating the electromagnetic drive system to accelerate the moveable electrode structure in a second direction relative to the axis.

The present invention also relates to providing structure and associated methods to allow the use of small form factor SSR relays in various contexts, including in data center environments. This can be an important issue because of the difference in the transfer time of standard mechanical contact relays vs. solid-state relays, which are much faster. Mechanical relays are usually constructed with the contacts mounted (usually on an armature) so that they can be moved to accomplish their switching function. The contact mass, shape, range of motion, mechanical leverage and force used to move the armature are all relay design issues. The range of motion is dictated by the gap needed between the contacts to minimize arcing at the maximum design current level and voltage rating. As the maximum design current is increased, the gap must also increase. The mass of the contact must be accelerated by the force applied to the armature, which has a practical limit. These factors impose a limit on the amount of current that can be sent through a pair of contacts in a mechanical relay and still maintain an acceptable transfer time for EDP equipment. EDP equipment CBEMA guidelines recommend a maximum of approximately 20 milliseconds of power outage for continued operation of modern switched power supplies. If the mass of the armature and contact gap are too large, the relay transfer time exceeds this time limit.

Solid State Relays do not have the transfer time limitations of mechanical relays, they have transfer times that are generally faster than traditional mechanical relays. However, they are less efficient, they waste approximately 1-3% of the current that flows through them as heat, which is much more than traditional mechanical relays waste.

Accordingly, another aspect of the present invention relates to providing improved packaging methods for SSR relays which allows them to be used in place of traditional standard small form-factor mechanical relays in a variety of contexts. They can be used in the design of automatic transfer switches (ATS), for switching between two or more power sources (e.g., due to power failures such as outages or power quality issues), as well as other power distribution components. Some of the objectives of this aspect of the invention include the following:

Providing methods to enable the of use of small form factor SSD relays in the place of traditional standard small form-factor mechanical relays, particularly in devices that have small form factors and therefore have not used such SSD relays due to issues with disposing of the extra waste heat that SSD relays produce relative to traditional mechanical relays of the same rated capacity;

Providing methods to efficiently dispose of the additional waste heat; and

Providing options to design engineers to cost-effectively use the invention in existing designs.

In accordance with this aspect of the present invention, a method and apparatus (“utility”) is provided for a switching power. The utility involves implementing a relay on a printed circuit board. The relay is operative for switching power between a first contact associated with the first circuit and a second contact. The relay is mounted on a housing structure for at least partially enclosing the relay. Multiple heat sink elements are provided within the housing for dissipating heat generated by the relay in operation. For example, the heat sink elements may comprise “U” shaped jumpers formed from a heat conducting material or other jumpers or wires extending between opposite sides of the housing. The utility further includes a fan position for producing air flow across the heat sink elements. In a preferred implementation, a sub-miniature fan is mounted on the housing to generate the air flow.

The invention disclosed can also be incorporated in a variety of apparatus, for example such as described in U.S. patent application Ser. No. 13/108,824, filed on May 16, 2011, entitled, “POWER DISTRIBUTION METHODOLOGY.” This allows the creation of auto-switched power distribution methods that incorporate auto-switching as an integrated feature of the power distribution methodology.

### BRIEF DESCRIPTION OF THE DRAWINGS

The present disclosure is described in conjunction with the appended figures:

FIG. 1a shows an example of a cross section along the major axis of a general example of the embodiment of the invention.

FIG. 1b shows an example of a cross section through the radial axis of a general example of the embodiment of the invention.

FIG. 2a shows an example of prior art describing a generic loudspeaker containing electromotive drive components directly applicable to the example relay mechanism.

FIG. 2b shows an example of the application of loudspeaker type electromotive drive components as applied to the example relay mechanism.

FIG. 3 shows a table of materials properties directly relevant to the application of the invention.

FIG. 4 shows the relevant components of the example relay at rest in the electrically disconnected, or Open State (OS).

FIG. 5 shows the relevant components of the example relay at the initiation of changing state from open to closed.

FIG. 6 shows the relevant components of the example relay at the midpoint of changing state from open to closed.

FIG. 7 shows the relevant components of the example relay nearing completion of changing state from open to closed.

FIG. 8 shows the relevant components of the example relay at the completion of changing state from open to closed.

FIG. 9a shows the orthogonal and cross section views of a typical loudspeaker type spider and the variation utilized in the example relay.

FIG. 9b shows the cross-section views demonstrating the condition of the spiders utilized in the example relay in three states i) in of the parked OS, ii) in the mid-transfer state and iii) in the parked Closed State (CS).

FIG. 10 shows an alternate construction of a relay in accordance with the invention.

FIG. 11 shows an example of a typical general-purpose relay in the non-energized (open) state;

FIG. 12 shows an example of a typical general-purpose relay in the energized (closed) state;

FIG. 13 shows an example of a relay in accordance with the present invention, in the open state;

FIG. 14 shows an example of a relay in accordance with the present invention, in the closed state;

FIG. 15a shows a synchogram of the basic operation sequence associated with a full energize to de-energized cycle, in accordance with the present invention;

FIG. 15b shows a configuration of electrical components for an all-analog drive circuit to accomplish the stages of operation described in FIG. 5a, in accordance with the present invention;

FIG. 16a shows an alternative analog drive circuit example that includes pulsed “Hold” current and the relevant synchogram, in accordance with the present invention;

FIG. 16b show synchograms that only represent the energization phase, and these are intended to show the similarity to the analog driver stages for the energize half of the complete cycle, in accordance with the present invention;

FIG. 17a shows an alternative construction in accordance with the present invention;

FIG. 17b shows a possible driver circuit, in accordance with the present invention;

FIG. 18 shows a example of a typical G2RL mechanical relay as referenced in the discussion of the invention;

FIG. 19 shows the electrical configuration of a typical G2RL mechanical relay;

FIG. 20 shows an example G2RL SSD relay in accordance with the invention;

FIG. 21 illustrates a mechanical cross-section of an example G2RL SSD relay in accordance with the invention;

FIG. 22 depicts a cross section of an example G2RL relay discussed in accordance with the invention; and

FIG. 23 depicts an alternate instantiation of the heat sinking jumpers in accordance with the invention.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

The present invention relates to improving the transfer time of relays in various contexts including power distribution and management in the home and office and in data center environments. A variety of relay implementations are disclosed in this regard having relative advantages for different applications. The following description is divided into three parts. The first part describes a hybrid relay including mechanical and electrically conductive fluid components. The second section describes a relay where an armature is accelerated in decelerated in fight for fast response with reduced landing speed. Finally, a solid-state relay with a compact form factor is disclosed.

### Hybrid Relay

This section describes a method to construct conductive liquid-wetted (mercury is used as the example liquid in the descriptions that follow, other conductive liquid materials or mixtures might be used to advantage) contact relay or switch assemblies. In the example relay the contacts are hermetically sealed in a chosen environment, for reasons that are detailed below. The simple example design facilitates manufacture by an assembly sequence that ensures precise control of mercury film maintenance and exact parts positioning and can be readily automated even for subminiature sizes. The example relay disclosed in accordance with this invention has a relatively fast response time for the degree of current it is capable of switching. The example relay will switch on or off in a time period not to exceed one-half of an AC power cycle, or roughly 8 milliseconds in the U.S., where utility power is 60 Hz. This is a worst-case scenario, in other conditions the transfer time of the example relay can be much less, which will be discussed below. In addition, because no parts are in significant frictional contact, nor is there any direct points of impact, the life expectancy (durability, MTBF) is very high. The design lends itself well to automated assembly processes and utilizes existing mass production techniques well established for the electromotive portion of the assembly. This invention can be a direct competitor as a replacement to widely used Solid State Relays (SSR), with the major advantage of efficiency, it does not waste power in a semiconductor voltage drop. The example relay design shown has very high efficiency using innovative conductor to conductor contact methods with minimal voltage drop.

### Design Considerations

Relays and switches of the mercury-wetted contact type have long been known for their good operating-cycle life and relative freedom from contact bounce. These and other advantages largely stem from the fact that the mercury contact film surface resists spark deterioration, improves dry-circuit (low current) circuit integrity, and provides mechanical damping that reduces bounce and chatter even with very small and low-inertia moving parts. Mercury, or liquid conduction, also allows for electrical contact to be made without solid part-to-part impacts. Having no moving electrical path parts that rub or strike against each other results in very long service life and very high cycle count durability. The principal disadvantages of such relays have been the necessity for compromises between providing an adequate mercury supply over long periods and the difficulties (bridging of insulating parts) if an excess of mercury is provided. A key issue is how to ensure the mercury in the device stays where it is placed and used and remains functional for the service life of the device. This difficulty also tends to make the devices orientation sensitive. Also, the necessity for accurate gauging of the quantity of free mercury maintained in a reservoir or pool has made many designs unduly expensive, and inhibited automated assembly; moreover, in those designs which eliminate the mercury reservoir, and rely on capillary action for mercury film maintenance, gradual failure of the supply has tended to negate the long-life expectancy predicted by theory. In addition, limitations in current handling characteristics due to the relatively poor conductivity of mercury has resulted in common variations of mercury wetted power relays becoming less desirable due to the relatively large volume of mercury required for significant current handling. Mercury, dispersed in the environment in significant quantities is toxic and is not sound environmental practice, as well as having a significant cost component.

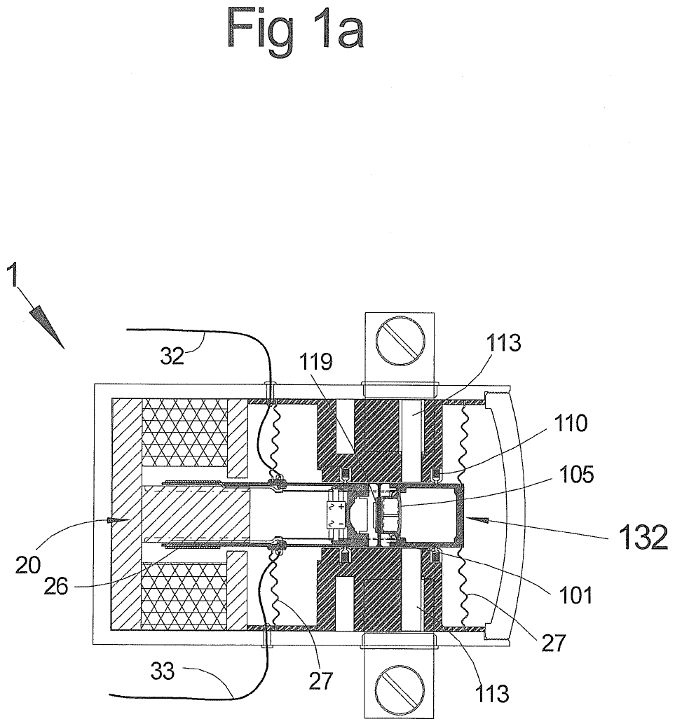

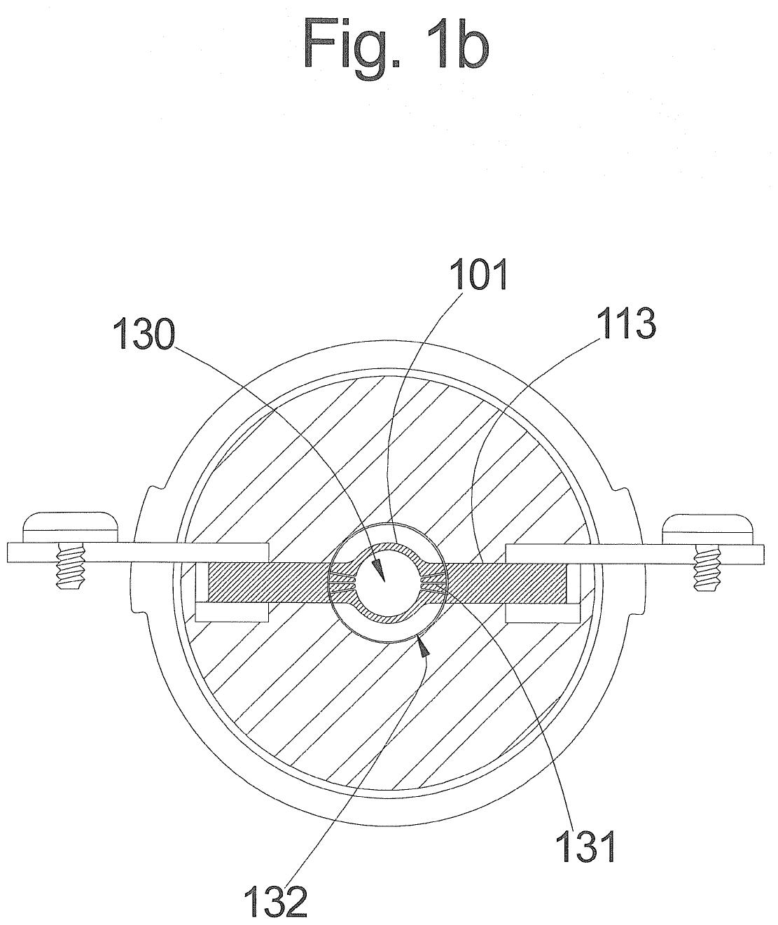

For the purposes of the descriptions in this document, referring to FIG. 1, the primary electrical attachment points (113) and the link tips (101) are sometimes referred to as “contacts”, and the space between them as the “contact gap”. They do not physically touch and electrical conduction between them is only established by filling the gap between them with mercury or other suitable conductive liquid, in a controlled fashion as will be discussed below.

The invention can incorporate one or more of several innovative features:
The contact gap dimensions, and volume are minimized to the space necessary to provide sufficient insulation when the relay is open (taking into account any residual wetting effects of the conductive liquid). This in turn helps to minimize the amount of conductive liquid necessary to fill the contact gap to close the relay.
The conductive liquid is held in reservoirs and used in contact geometries that help maximize the effect of the surface tension of the liquid to assist in efficiently moving the liquid into and out of the contact gap(s) and liquid reservoir(s). This also helps to ensure that the relay can properly operate in many orientations.
The conductive liquid is used in contact geometries that help to maximize the efficiency of electrical current transmission through the electrical conduction path, thereby minimizing the amount of resistive loss due to the conductive liquid. This can be done by minimizing the contact gap dimensions as described above and designing the contact geometry appropriately. The example relay shown uses approximately 0.3 micro-liters of mercury per one ampere that flows through it, which is very little liquid for any mercury wetted device that is designed to carry one ampere or more; we know of no switching or relay devices rated for greater than one ampere that use one micro-liter of conductive liquid per ampere of rated capacity, other than specialized reed types. In the example relay whose description follows, the contact area is relatively large relative to the current flowing through it. This fact, combined with the minimized contact gap means that the conductive path through the liquid is short and can use a large area of the contacts. This minimizes resistive loss if the liquid is less conductive than the solid contact material. Other conductive liquids can have the contact geometry and gaps optimized to best use their specific properties.
The conductive liquid is moved into the contact gaps (and out of the reservoirs) using fast acting mechanical methods. In the example shown, a piezo-electric disk is shown as the motive device. Other methods could be used, for example a miniature solenoid activated plunger, etc.
The use of a conductive liquid means that there is no necessity for the solid contacts to touch each other in normal operation. This allows the design of a relay with a very long service life, due to almost no wear on the contacts. The other parts of the assembly that move can be built with appropriate construction and materials for the desired service life.
The relay assembly can be vacuum sealed at a low pressure (or potentially a specified gaseous mix used to advantage at a desired optimized pressure in a sealed relay assembly) to facilitate the control and retention of the conductive liquid and potentially improve the amperage and voltage capacity of the relay. In the example that follows, mercury is used, and the relay is vacuum sealed and the functional benefits of this variant are described. Other variations, such as an over-pressure sealed relay chambers using inert gases might also be advantageous. Depending on the conductive liquid chosen, their reservoirs could incorporate sealed gases that have beneficial effects on the long-term stability of the conductive liquid.
The contacts can be designed to move, and their movement controlled so that the combination of moving the conductive liquid into (or out of) the contact gap and the movement of the contacts combine to advantage. This technique can help in insuring that the relay properly breaks and connects the electrical connectivity paths.
The contact materials and construction can be specifically chosen to best function with the chosen conductive liquid. This is described in the example relay described below and is an important feature of the design. Different contact materials and construction techniques can be chosen and optimized to work best together.
The ability to quickly move the conductive liquid allows very fast actuation times when used in a controlled application environment, (for example “cycle-stealing” as described in U.S. Pat. No. 8,374,729, issued on Feb. 12, 2013, entitled, SMART ELECTRICAL OUTLETS AND ASSOCIATED NETWORKS) where the time at which switching the relay on or off is known in relation to the state of the AC cycle and/or when “zero voltage crossings” will occur. The example relay will be able to actuate from on to off and off to on in approximately one half of a millisecond in such a scenario. When the state of the AC cycle is random in relation to the time when a command to switch the example relay is given, the actuation time of the example relay is similar to solid-state switches because the design shown would need to wait for the next available “zero voltage crossing” before actuating, which could be up to eight milliseconds. This constraint is the same for current solid-state switches and the example relay. Other possible variants of the current invention may not share this limitation.

### Example Relay Components

Two primary components of the relay assembly (1) of this example are the electrical contact section, switch, and the electromotive actuator, or motor. FIG. 1a depicts a cross-section of the invention through the longitudinal axis, and FIG. 1b is a cross-section through the contact area in a radial fashion. The principal components of the relay assembly (1) are an electromotive source, or motor (20) and a primary electrical switch assembly (132). Primary electrical switching attachment points (113) are switched by a moveable switching link (101) which is moved in and out of the switched on and switched off position axially by the motor (20) in response to electrical signals delivered to the coil (26) via the flexible leads (32, 33). Centering of the piston assembly while allowing essentially free movement along the longitudinal axis is enabled by spiders (27). The switching link (101), heretofore called the link, has an internal chamber called the mercury reservoir (119). The mercury reservoir has portals from the volume space of that reservoir to the tips of the link (101). A piezoelectric disk bender (105) is attached to the front of the mercury reservoir (119) in such a manner as to allow displacement of a small amount of mercury (or other suitable electrically conductive liquid) by application of a small current to the piezoelectric element (105) That small amount of mercury will be inserted in the gap between the tips of the link and the primary electrical switching attachment points (113) to complete the electrical path while maintaining the gap, the tips of the link and the primary electrical switching attachment points never touch each other. In other words, when the motor axially positions the link (101) in between the primary electrical switching attachment points (113), the piezoelectric disk bender will relax and force flow of electrically conductive liquid, mercury in this example, into the gap formed between the link (101) tips and the primary electrical switching attachment points (113).

The function of the mercury reservoir is a fundamental concept of this invention. A combination of the piezoelectric element moving the mercury and mechanical motion from a different electromotive source is used to create a sufficient gap in the electrical switching members to insure non-conduction of even high AC voltages, such as US standard 120, 208, and 277 Volts AC, or European voltages of 220, 230 and 240 Volts AC, when the relay is open. The gap resulting in the non-contact of the link and the primary electrical switching attachment points is filled at the last possible moment by the electrically conductive mercury by the action of the piezoelectric element. In this manner, very fast initial connection and disconnection of the primary switch can be obtained by the movement of very small amounts of mercury, while the relatively large inertia of the piston is then moved such that the needed position between the primary electrical switching attachment points is obtained, they are either offset (open position) or aligned (closed position). This combination of very fast initial switching, followed by the slower action of moving the link physically to the open or closed position allows for higher voltage and currents to be switched effectively.

The instantiation of the invention described is intended for use with alternating current electrical sources. The action of the invention is dependent on the electrical voltage and current of the source passing through the zero point for the current every one-half cycle. At that moment, electronic drive circuits will have initiated the motion of the mercury in a manner such that the contact between the mercury and the primary electrical switching attachment points is either made or disconnected. Thus, the mercury will be touching, or not touching the electrical switching attachment point concurrent to when there is no, or little current and voltage. This precise control of the mechanical connection time is made possible by the electronic drive timing circuit and the very low volume of mercury in the very small reservoir associated with filling or evacuating the gap between the link and the primary electrical switching attachment points.

A relay disconnect sequence will now be described. As the AC cycle proceeds past the zero crossing, the voltage increases and the movement of the piston proceeds, retreating the link in a disconnect sequence. This retreating is faster than the rate of rise of the AC voltage now forming across the gap between the link and the primary electrical switching attachment points. Meanwhile, the mercury has been fully retracted into the reservoir via the action of piezo disk bender until the piston comes to rest in the switch open position at the other end of the travel of the spiders.

FIG. 1b depicts a cross section radially through the link (1), piston assembly (132), and primary electrical switching attachment points (113) while the overall relay assembly is in the switched closed position. The electrically conductive material, mercury, is contained in a reservoir (13) and delivered to the gap between the link (101) and the primary electrical switching attachment points (113) via one or more ports (131).

### Example Relay Operation

The first discussion will be of the motor, which is a linear actuation type most commonly found in audio applications. Loudspeakers, or speakers, are well known in the art and are commonly used in a variety of applications, such as in home theater stereo systems, car audio systems, indoor and outdoor concert halls, and miniaturized forms are widely found in headphones, cell phones and the like. A loudspeaker typically includes an acoustic transducer comprised of an electromechanical device which converts an electrical signal into acoustical energy in the form of sound waves and an enclosure for directing the sound waves produced upon application of the electrical control. For this invention, little concern is attached to the action of the electromotive forces on air to produce sound. But the principals, construction considerations and high-volume manufacturing processes used do apply to the electromotive portion of a loudspeaker in the sense that those components relate directly to the intended application.

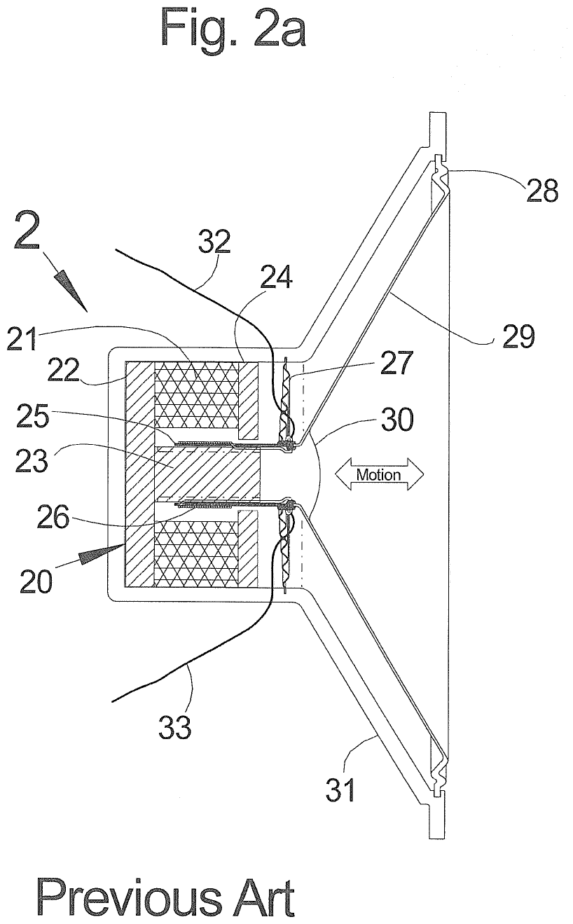

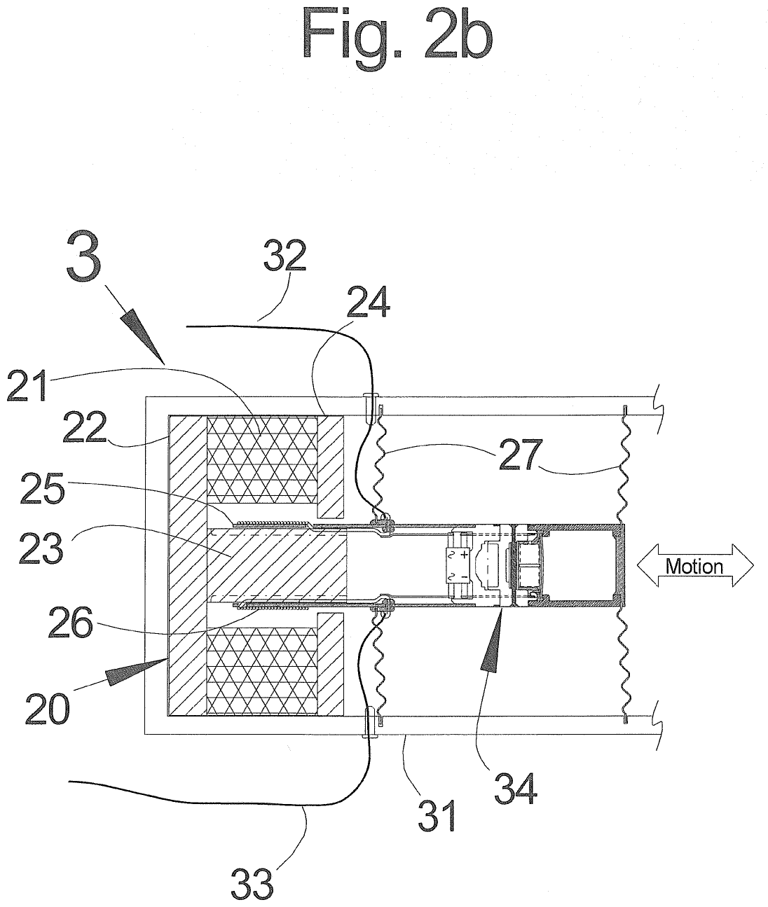

A loudspeaker, FIG. 2a, (2) comprises a coil of wire (26), typically referred to as a voice coil, which is suspended between a pole piece and a permanent magnet. In operation, an alternating current from an electronic current source (amplifier) flows through the voice coil, which produces a changing magnetic field around the voice coil. The changing magnetic field around the voice coil interacts with the magnetic field produced by the permanent magnet (21) to produce reciprocal forces on the voice coil representing the current in the voice coil.

The voice coil is disposed within the loudspeaker so that it can reciprocate in accordance with the forces imposed along the pole piece. The voice coil is attached to a cone shaped diaphragm (29) which vibrates in response to the reciprocal movement of the voice coil. The vibration of the diaphragm produces acoustic energy in the air, i.e., a sound wave. In the application of this invention, the movement of the voice coil is directly connected to the electrical switch, turning it on and off at a rate consistent with the electronic signal applied to the voice coil. For purpose of clarity, the voice coil will be henceforth referred to as the coil.

An example of components used in the construction of a conventional loudspeaker is shown in FIG. 2a. The loudspeaker (2) includes a speaker cone (29), a surround flex (28), a coil bobbin (25), and a dust cap (30). The diaphragm (29), the dust cap (30) and the coil bobbin (25) are attached to one another by, for example, an adhesive. Typically, the coil bobbin (25) is made of a high temperature resistant material such as glass fiber or aluminum around which an electrical winding or a coil (26) is attached such as by an adhesive. The coil (26) is connected to suitable leads (32, 33) to receive an electrical input signal from the electronic current source (henceforth referred to as the input signal).

The diaphragm (29) is provided with a surround flex (28) at its peripheral made of a flexible material such as a urethane foam, butyl rubber or the like. The diaphragm (29) is connected to the speaker frame (31) at the surround flex, (28) by means of, for example, an adhesive. At about the middle of the speaker frame (31), the intersection of the diaphragm (29) and the coil bobbin (25) is connected to the speaker frame (31) through a inner suspension, henceforth called a spider, (27) made of a flexible material such as cotton with phenolic resin, woven fiberglass or carbon filaments and the like. The periphery surround (28) and the spider (27) allow the flexible linear movements of the diaphragm (29) in a single axis, as well as limit or damp the amplitudes (movable distance in an axial direction) of the diaphragm (29) when it is moved in response to the electrical input signal.

The loudspeaker (2) also comprises a magnetic assembly (20) formed of an air gap between the front plate (24) and the core pole (23). The air gap has a strong magnetic flux across it induced from the magnet (21) through the back plate (22), the core (23) and the front plate (24). In this example, the core pole (23) has a back plate (22) bonded at its mating surfaces. The core pole (23) has grooves for the coil wire feeds to pass in.

The permanent magnet (21) is disposed between the front plate (24) and the back plate (22) of the core pole (23). The back plate (22), front plat (24) and the core pole (23) are constructed from a material capable of carrying magnetic flux, such as iron. Therefore. a magnetic path is created through the pole piece (23), the front plate (24), the permanent magnet (21) and the back plate (22) through which the magnetic flux is running. The air gap is created between the core pole (23) and the front plate (24) in which the coil (26) and the coil bobbin (25) are inserted in. Thus, when the electrical input signal is applied to the coil (26), the current flowing in the coil (26) and the magnetic flux, they interact with one another to produce electromotive force. This interaction produces a force on the coil (26) which is proportional to the product of the current and the flux density. This force results in the movement of the coil (26) and the coil bobbin (25), which moves the diaphragm (29), thereby producing the sound waves. In the application of this invention, the diaphragm is replaced by a tubular extension of the bobbin in which the primary electrical switch contact is housed. Hereafter, this extension and the bobbin will be referred to as the piston.

In FIG. 2b the basic components of the motor section of this invention are described. The description of the loudspeaker motor applies directly. In fact, the construction of the components are so similar that existing production means for mass production directly apply to this invention, hence, the detailed description of the “loudspeaker”. In FIG. 2b, it should be noted that the motor is exactly the same as in the Fig. of 2a, the loudspeaker. The description of its operation is exactly the same and references previously made describing the motion are the same. The diaphragm of FIG. 2a is replaced with a piston assembly (34). Presuming the electromotive forces generated in the coil (26) are producing linear motion along the major axis of the assembly, it can be clearly observed that the piston assembly (34) will move similarly. An additional spider (27) is located at the front end of the piston assembly (34) and provides a second concentric support, flexible only in one axis now when connected to the spider at the back of the piston assembly (34).

The contact assembly, or piston, is essentially of concentric or cylindrical symmetry fabricated of circular or tubular subassemblies, machined tubular inserts and plastic, of various compositions, injection molded when applicable, placed together in a stack assembly process which inherently ensures precise positioning of the parts, including the contact spacing. In addition, the volume of the mercury reservoir chamber is precisely controlled. Special treatment of certain of the parts for control of mercury wettability permits exact gauging of the supply of mercury for permanent optimization of the mercury film without any pooling or excess. Use of commonly available ferro-fluid seals are also partly responsible for the containment of mercury and can increase the operating life of the example relay. Other forms of seals may be used (or added in addition, if this is found to be desirable for extended service life or other considerations) such as viton™, at some potential performance degredation, due to increased friction and/or shorter service life, however this may be a worthwhile cost-benefit tradeoff. Provision of the desired gaseous atmosphere, preferably a noble gas, is facilitated in that conventional out-gassing and sealing off machinery can be utilized, as in miniature lamp manufacture. In brief, this preferred embodiment of the relay comprises a central moving contact element in the form of an electrically isolated piston with a mercury wetted pair of contacts. The contact piston is actuated by a electromotive linear motor very similar to what is commonly found in loudspeakers. In the description which follows, the term “wet by mercury” refers to a surface which is wettable by mercury, (or by any suitable electrically conductive liquid), and which is in fact wetted by a film of the mercury applied thereto. Wettability may be inherent in the material of which the surface is a boundary or may be imparted (or prevented) in other cases by appropriate surface treatment, plating, or cladding, as described below. Non-wettability, heretofore called Hg-phobic, is also a critical consideration in this example. Materials such as Tantalum, Chromium and Tungsten are examples of Hg-phobic conductors. Materials such as Silver, Gold and Copper are Hg-wettable. The term “magnetic” applied to materials refers to those whose magnetic permeability is substantially greater, or many times greater, than that of air; for example, mild iron or steel. No permanent residual magnetization or high degree of remanence magnetization is intended to be implied by the unqualified term “magnetic.”

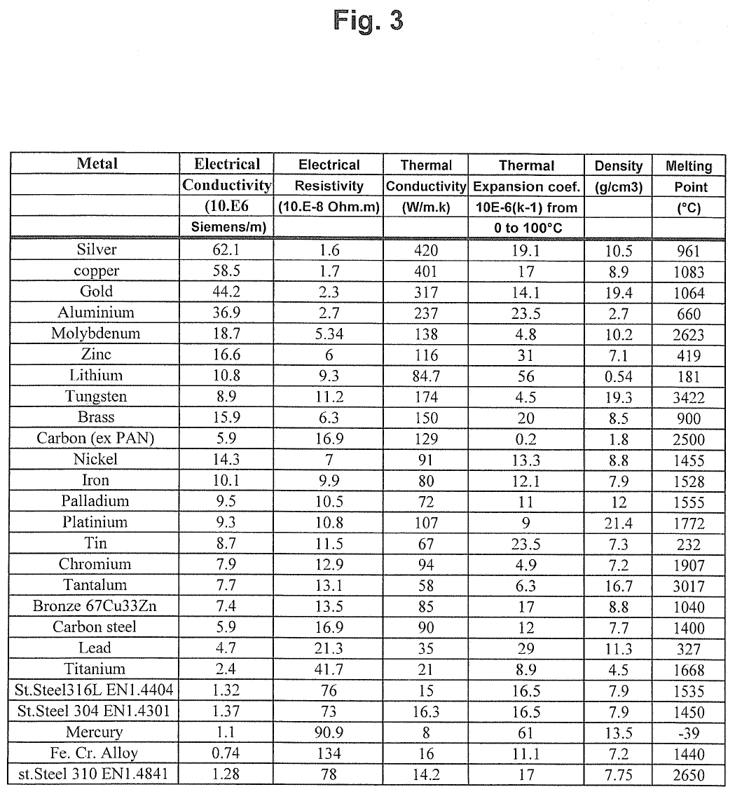

FIG. 3 shows various metals and some of their electrical and physical properties. Selection of various metals for specific purposes in the example relay is dependent on the characteristics of each metal, and the application of various electrical and mechanical stresses on those materials. For example, the primary electrical switching attachment points and the link are principally made of either brass or copper due to their very low resistance, or inversely the very high electrical conductivity, as well as low cost and ease of manufacturing. The surfaces of electrical mating with the mercury, such as at the tips of the link, and the inside bore of the primary electrical switching attachment points are plated with a much higher melting point material such as Tungsten, Lithium, Chromium or Tantalum to reduce loss of material from electrical arcing at the moment of connect or disconnect. Even though the timing circuit, and design of the high-speed mercury displacement, occurs at or near the zero crossing of voltage and current, it is impossible to time this perfectly. There will always be some level of voltage difference between the switching components. Thus, having higher melting points reduces the volume of material affected by that arcing. Selection of these materials is further defined by the wetting characteristics of the mercury to each. A plating of suitable Hg-phobic characteristics will result in reduced mercury retention on the mating surface when the mercury is retracted, thus leaving a greater gap between the link and the primary electrical switching attachment points. Materials such as Tantalum and Tungsten are good but have difficulty in either availability or application. Chromium is also a good Hg-phobic material but has lower electrical conductivity. Selection of the proper plating will ultimately be defined by the expected current, voltage and durability of the relay with respect to cost of manufacturing. The initial construction of the example relay utilizes Chromium due to the ease of application, low cost and relative durability. Improved performance or form factors may be realized by application of Tantalum or Tungsten.

The design of the outer shell of the example relay includes hermetic sealing. This is necessary for two purposes. One is to reduce the formation of chemical by-products from the microscopic arcing occurring at the moment of connection and disconnection as a result of local vaporization of small amounts of mercury and the contact surfaces. In the presence of reactive gasses such as oxygen in the air, the oxides formed probably would eventually cause failure of the electrical connections during the switched-on condition of the relay. In addition, hermetic sealing reduces the possibility or releasing the element mercury to the environment. An additional function of the hermetic seal is to contain a gas such as Argon or Krypton due to the inert nature of these gasses. However, practical experience has demonstrated that Hydrogen in mercury switches is also a good option but is more difficult to contain. Again, selection of the particular gas is dependent on the intended application of variants of the invention. In any case, a hermetic seal is necessary to allow use of some type of gas to displace oxygen, or support a vacuum, which also has certain other potential benefits, for example greater resistance to contact arcing. The example relay utilizes Argon gas at a static pressure of 2 bar.

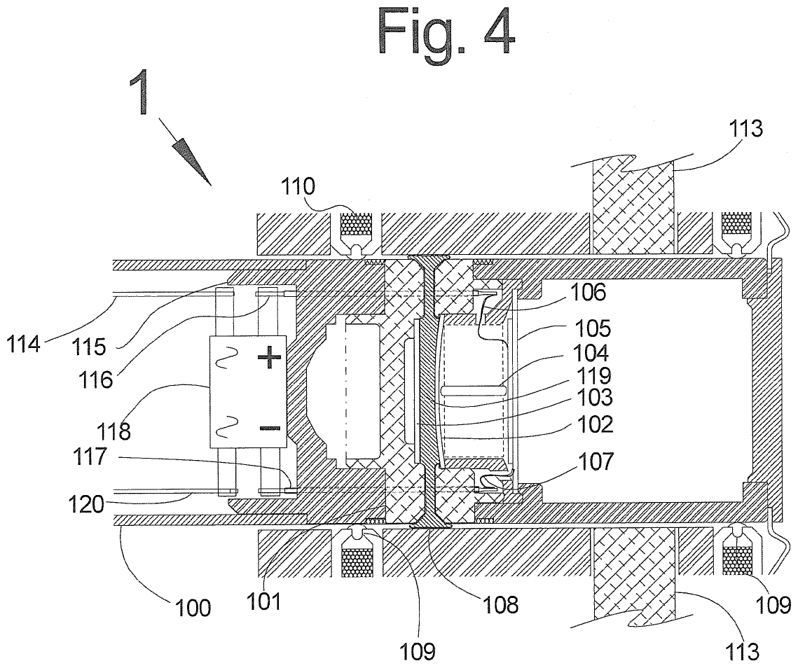

A sequence of steps from the disconnected state of the invention to the connected state are described in FIGS. 4 through FIG. 8. The connection sequence is essentially reversed for the disconnect sequence, variations will be discussed as necessary.

To aid in understanding the details of how the mercury liquid is used in the example relay, the following description is provided.

When the example relay is at rest in the open position, the piezoelectric disk bender(s) is disposed such that the contents of the mercury reservoir are expelled into the contact gap(s), even though the piston is retracted. This is done to aid in the long-term retention of mercury, as having mercury in the contact gap(s) tends to help any residual mercury in this area rejoin the liquid mass, which aids in long term function of the relay.

When the example relay is directed to close, the piezoelectric disks are controlled to initially move the mercury from the contact gap areas back into the reservoir and then at a chosen time in the relay closure operation, move it back into the contact gap(s). This is done in conjunction with how the AC cycle is moving towards a “zero voltage crossing” to control the location of the mercury in relation to the voltage potential across the contacts and is discussed in more detail below.

Referencing FIG. 4, additional components of the piston and surrounding bore are shown. This view is representative of the switch (1) element of the example relay, with the electromotive action of moving the piston being assumed from previous discussion of the motor.

Wires (114, 120) deliver current being applied to the motor to a bridge rectifier (118). The purpose of the bridge rectifier is to deliver a DC voltage to the Piezo disc bender (105) via link wires (116, 117) in the same polarity, regardless of the direction of applied voltage to the coil previously discussed in the motor description. Thus, regardless of the direction of actuation of the piston assembly, either traveling towards making switching contact, or retreating to disconnect the switch, the piezoelectric disc bender will actuate such that it moves mercury into the reservoir by extracting the mercury from the contact gaps via the tips of the ports on both ends of the reservoir. An insulating material such as polyethylene is used as a support base (115) of the various components of the piston and switch assembly. The mercury reservoir is constrained on the back and front faces of the mercury by elastomeric discs (102, 103) such that forces acting upon those discs can effect bending of the discs, thus changing the overall volume of the reservoir. It should be noted that the depiction is exaggerated, and the volumes of the reservoir, and diameter of the port(s) is exaggerated to help describe the operation. The mercury (119) is shown being compressed such that it is slightly filling the gap between the link (101) and the bore of the insulated outer housing at point (108). The compression is due to the lack of any current in the drive motor, the switch is at rest, a stable state, or the Open State, OS. The alternative state is the Closed State, or CS. This example relay is of a class referred to as a latching relay, e.g., once switched, it stays in that state until further action is taken to change the state. The mercury reservoir is compressed by the fact that the piezo disc bender is not being electrically driven at this time and thus it is in the flattened position. This results in pressure being applied to push rod (104), pressing on the elastomeric disc, (102) henceforth called the front diaphragm, deflecting it and compressing the mercury reservoir. The push rod is necessary to maintain an acceptable spacing between the primary electrical switched components, and the piezoelectric element, which is electrically part of the drive circuit. This is commonly referred to in the industry as “coil” or “body” isolation. Seals (109) are concentrically configured around the piston to prevent trace amounts of vaporized, or particulated mercury from escaping. The axial motion of the piston will tend to re-collect the condensed mercury and replenish the supply resolving one of the problems mentioned earlier with mercury wetted relay construction of previous designs. The bobbin (100) of the motor is shown connected to the support base (115) by a friction interference fit, but other means of bonding are possible.

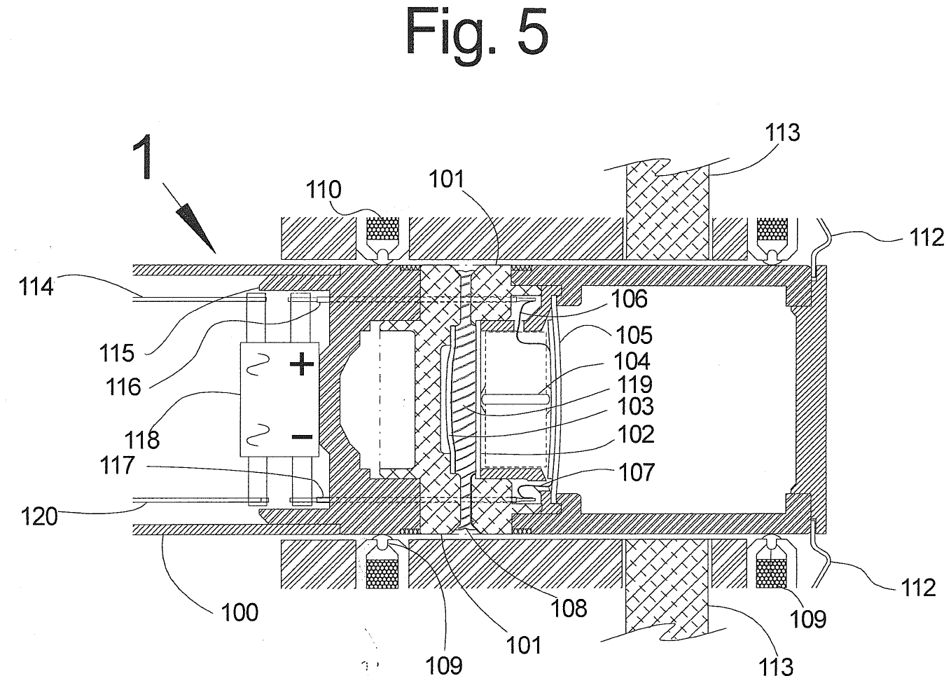

FIG. 5 depicts a time very shortly after the initiation of the connect switch cycle. At this point, the electronic driver has predicted the time of the crossing of the AC cycle through zero and has initiated the mechanical motion prior to that event. Since the mass and characteristics of the motor and the piston are reasonably predictable, the estimation of the arrival of the link (101) entering the primary contact bore (113) can be made with a fairly high degree of accuracy. Upon initial application of current to the motor coil, the piston begins to accelerate from left to right. Simultaneously, the motor current is also delivered through the bridge diode (118) to the piezo disc bender (105) causing it to bend outward relative to the mercury reservoir. This happens very rapidly on the order of less than 500 micro-seconds, as the disc bender and mercury reservoir are both of low mass. In the example relay, a total of approximately 15 milligrams of mercury are displaced. As a result, the surface of the mercury (108) retreats into the tips of the ports as the piston starts to move towards the primary switched contacts (113). In addition, as the acceleration of the piston occurs, the diaphragm at the back of the reservoir is slightly deflected from the inertia of the mercury (119) in the reservoir. At this stage of the sequence, this assists in the extraction of the mercury and pulling contact mercury back into the ports. A sufficient volume of mercury has already been moved into the ports from the effect of the piezo disc bender (105) at the onset of the start of the cycle. But the additional movement of mercury is beneficial from the standpoint of preparing for the end of the cycle. It should be noted the geometry and number of the ports has a significant influence on the velocity of change and stability of the surface tension in the contacting volume of mercury (or conductive liquid) between the link and the bore. The ports, reservoir and related geometric profiles shown in the example relay are presented for clarity of principal and may not exactly reflect the finalized details of an actual operational relay.

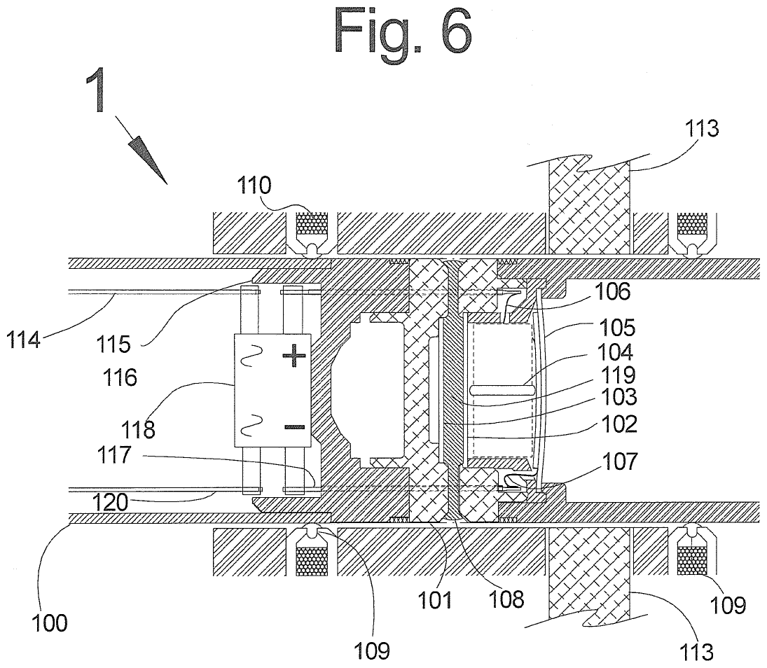

FIG. 6 shows the piston in mid cycle. Conditions are essentially the same as the acceleration step, but the velocity of the piston is at the maximum, and the back diaphragm is now flattened out, thus pushing some of the mercury in the reservoir towards the ports. This action is not instantaneous, but rather a protracted change of direction and velocities of molecular flow (fluid properties) of the mercury, or similar conductive liquid. These operations are happening in the tens of microseconds timeframe, and due to the inertia of the mercury, the acceleration and de-acceleration of the flows is spread out over a great percentage of the stroke of the piston. Suffice it to say, at the mid-point, when the current to the coil is reversed to start the de-acceleration phase of the piston, the piezo disc bender (105) remains bent due to the rectifier (118) action, and the volume in the reservoir remains effectively unchanged.

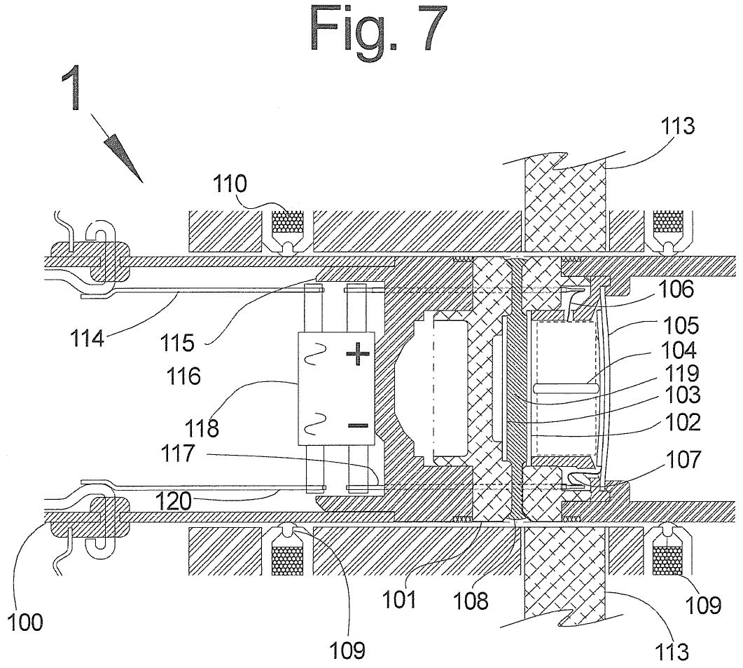

FIG. 7 shows the piston nearing the end of the de-acceleration phase. The link (101) has entered the gap in the primary contact bore (113), but electrical contact has not yet been made. The AC cycle of applied voltage between the terminals of the primary contact bore is now approaching zero, but still is not there. But the voltage is now low enough that arcing between the contacts is not possible due to the gap between the bore and the link.

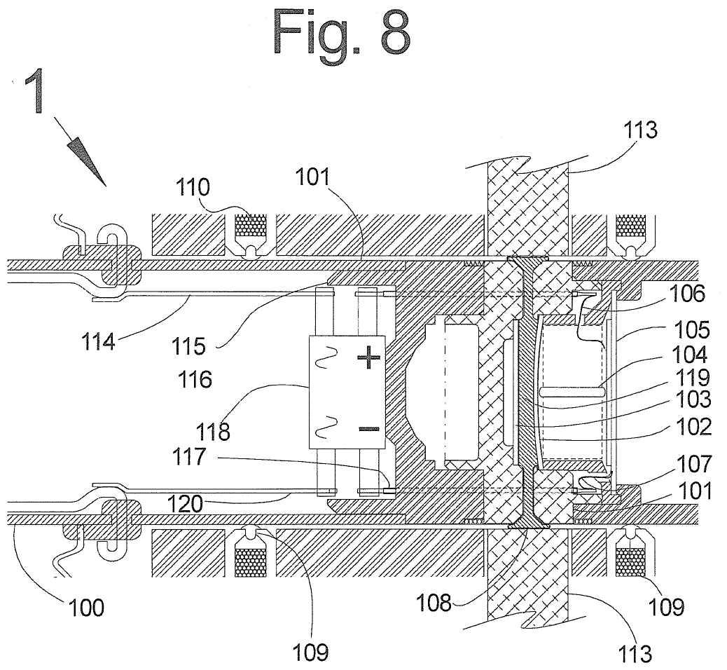

FIG. 8 shows the completion of the switch closure operation. The piston has fully inserted the link (101) between the primary contact bore (113), the AC cycle has just reached the zero-voltage point, and the current to the motor coil has been removed. At this moment, (slightly before in practice) the piezo disc bender (105) has flattened back out due to the loss of current in it. It pushes on the push rod (104), which in turn presses on the front diaphragm (102) displacing the last volume of mercury from the reservoir necessary to close the gap between the link and the primary switch contacts (113), thus completing the electrical circuit. The back diaphragm (103) absorbs the shock wave formed in the mercury reservoir (119) from the nearly instantaneous pressure rise when the piezo disc bender (105) loses current, Selection of the elastomeric properties of the back diaphragm is dependent on numerous variables, but ultimately has been selected to allow a smooth transition of mercury into the gap (108) with little over-shoot. This is damping and will improve the tendency of the mercury to remain a monolithic volume of liquid, thus maintaining the cohesive integrity of the perimeter of the contacting volume of mercury (or conductive liquid) between the link and the bore.

The disconnection phase can now be clearly envisioned, as it is essentially the reverse sequence. The electronic source can predict when the mercury will retract from the face of the primary contact bore (113) with a high degree of accuracy, and hence make the physical electrical disconnection very nearly at the zero crossing, just as the piston motion begins to accelerate. The gap formed will suffice to open the electrical switch for the time necessary for the piston to remove the link (101) from the bore. As the AC voltage rises, the gap between the link (101) and the primary contact bore (113) increases at a rate grater than the ever-increasing voltage breakdown threshold. It stays “ahead” of the breakdown threshold. This acceleration phase must happen within about 3 milliseconds to prevent the breakdown threshold from being exceeded. Thus, the use of lightweight materials, small overall size of the link, low volume of mercury and reasonably high electromotive force from the motor.

It should be noted that the motor, being of a permanent magnet variety, can return energy from the acceleration phase back to the power supply during the de-acceleration phase. Since there is no significant friction between components, (minimal loss) much of the energy can be conserved, further reducing the power requirements of the switch operation as a whole.

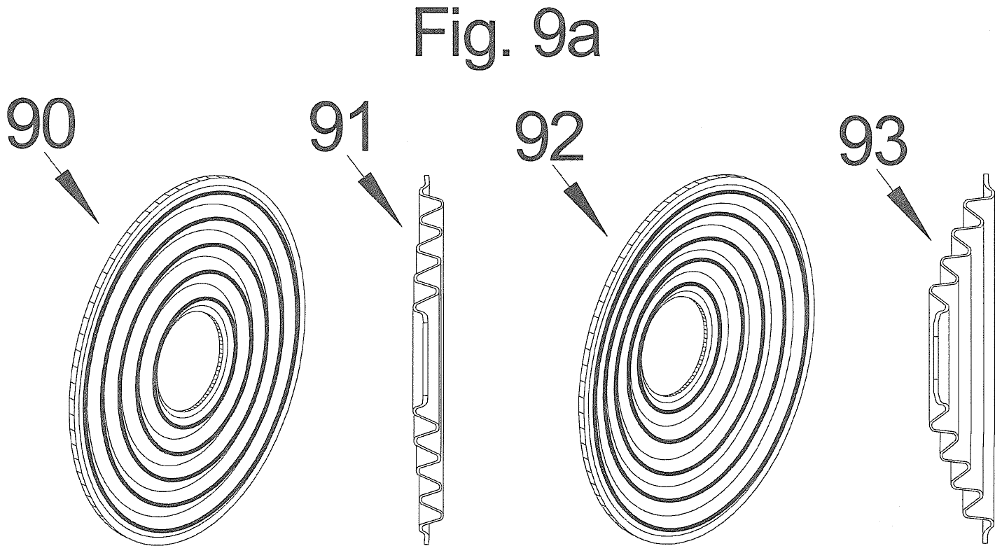

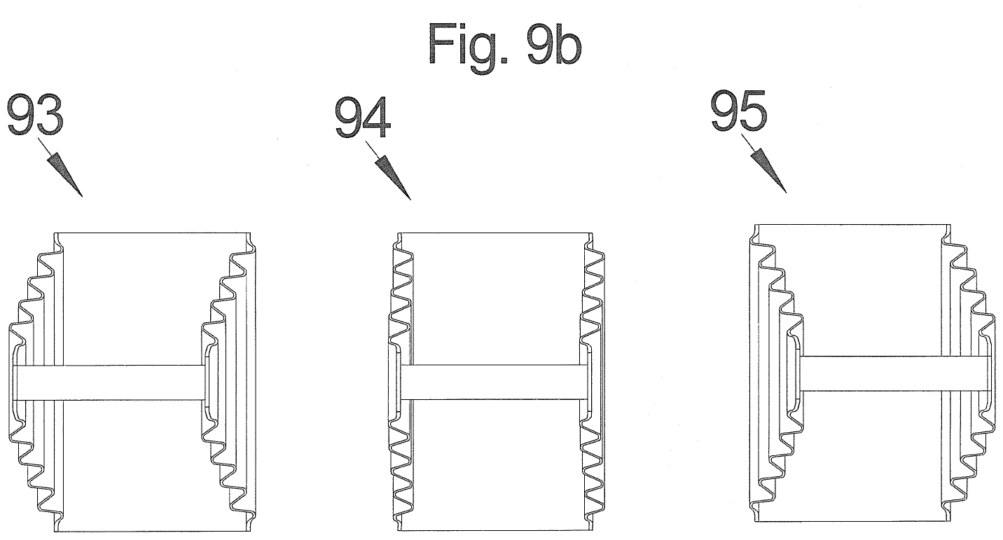

Because the example relay is of a bistable configuration, as mentioned earlier the equivalent of a latching relay, a means of holding the piston at either end of the stroke is necessary. This is done by an artifact of the use of the spider piston concentric supports. Observing FIG. 9a, the Orthogonal and cross section view of a typical speaker type spider is shown (90, 91). In the application of this example relay, the natural state of the formed spider is more of a concentric pleated cone. The degree of the pleating and cone depth are determined by the stroke and inertial placement holding characteristics needed to hold the switch in either closed or open positions for the intended application. For example, if the switch is used in a stationary application the tendency to hold the relative position of the piston is not as great as the requirement to hold it in a high vibration environment. In any case, adjustment of the holding force is determined by the stiffness, number, and depth of the pleats in the pair of spiders. From the view presented in FIG. 9b. It can be observed that when the cones described in 9a are connected together, such as on the piston, they will remain stable in the position shown in 93. If a force is applied, the cones will move relative to each other, but provide some resistance due to the shortening of the distance from pleat to pleat. Upon exiting the travel from left to right midpoint 84, the pleats now tend to try to expand to the natural shape and the core will continue the acceleration and ultimately come to rest finding a point of equilibrium at the opposite end of the stroke as shown in 95. The electronic circuits associated with driving the motor will counteract the acceleration at the end of the stroke, just before the closure of the switch is made, and thus can control smoothly the acceleration and de-acceleration. But the natural tendency of the spider cones to find equilibrium at each end of the stroke is put to advantage in establishing a bistable, or “latching” relay configuration. It should be noted that other stable points could be chosen for the equilibrium point(s), if desired.

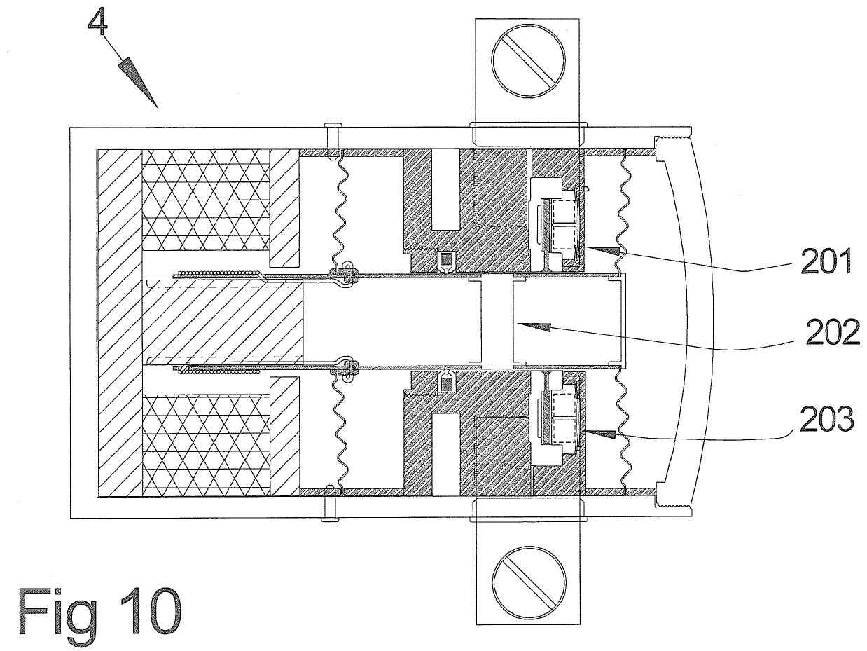

FIG. 10 depicts an alternate instantiation in accordance with the invention. Example relay (4) is of similar construction as the preferred instantiation of the invention discussed earlier, with the notable exception of a significantly lowered moving mass, which can be beneficial in to certain functional characteristics such as transfer time and may allow cost reductions. This is accomplished by moving the mercury reservoir, ports, and piezoelectric components into a pair of such on the stationary primary switch contacts (201,203) as shown, and a utilizing a straight through conductor (202) affixed to the piston. Electrical drive to the piezoelectric components is similar to the preferred instantiation described earlier with the notable difference that the rectifier bridge diode assembly is moved from the piston to a non-moving mass location, possibly external to the relay assembly.

### Accelerated Motion “Rocket” Relay

A design issue for relays used in electrical power switching, is transfer time of the relay. The contacts are mounted (usually on an armature) so that they can be moved to accomplish their switching function. The contact mass, shape, range of motion, mechanical leverage and force used to move the armature are all relay design issues. The range of motion is dictated by the gap needed between the contacts to minimize arcing at the maximum design current level and voltage rating. As the maximum design current is increased, the gap must also increase. The mass of the contact must be accelerated by the force applied to the armature, which has a practical limit. These factors impose a limit on the amount of current that can be sent through a pair of contacts and still maintain an acceptable transfer time for EDP equipment. EDP equipment CBEMA guidelines recommend a maximum of approximately 20 milliseconds of power outage for continued operation of modern switched power supplies. If the mass of the armature and contact gap are too large, the relay transfer time exceeds this time limit. Traditional techniques in this area were developed from prior industrial electrical practice.

This invention relates to improving the performance of existing electromechanical relays, herein referred to as the “relay”. It is an innovation that increases the speed at which the relay can make the transition from one state to the next (for example the de-energized state to the energized state) and back (for example from the energized state to the de-energized state). In addition, the concept also improves the characteristics of a condition commonly referred to as “bounce”, that occurs the moment when the contacts within the relay contact each other during either actuation or release. A further benefit of the concept is the improved life expectancy of said contacts by reducing the mechanical deformation of said contacts from repeated impacts with each other. An additional potential benefit is reduced arcing, which can also improve contact life and function (by avoiding degradation) plus reducing the potential for “arc welding” of contacts, which can be a catastrophic failure mode.

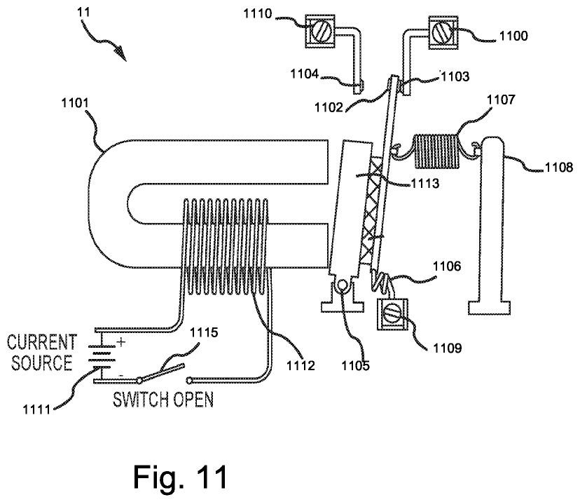

A generic relay is outlined in FIG. 11. Various trade names are associated with the components of this relay, but for clarity, names given here will be generic.

Turning to FIG. 11, The primary components of the relay (1100) are the magnetic core (1101), the electromagnetic coil (1112), the armature (1113), the return spring (1107) and the electrical contacts and connection elements (1101, 1102, 1103, 1104, 1106, 1109, and 1110). Shown also is a potential electric current source - a battery (1111), and a switch (1115) to turn on and off the supply of current to the coil. The switch is representative as is the battery, the switch could be a semiconductor, another relay, or any other means desired. Also shown on this relay (1100) is the pivot point (1105) that the armature moves about, and an insulator between the metal armature (1113) and the electrical path between the moving contact (1102) and the flex point (1106). This relay (1100) is shown in the non-energized state.

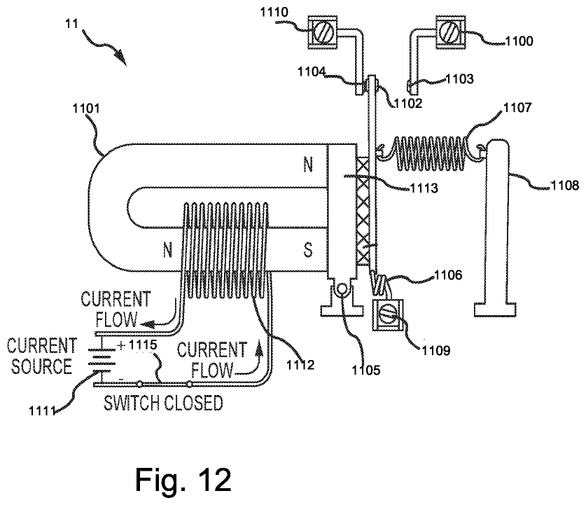

FIG. 12 represents the relay (11) in the energized state, or where current from the battery (1111) is being delivered to the coil (1112) via the switch (1115) closure. The resultant magnetic field build up in the core (1101) attracts the armature (1113), stretches the spring (1107) against its mounting point (1108), which in turn moves the moving contact (1102) called the common, or C, away from the stationary normally closed, or NC, contact (1103) and towards and landing upon the normally open, or NO, contact (1104). Current could now flow from the common terminal (1109) to the NO terminal (1110). This is the standard and most commonly applied configuration for general purpose electromagnetic relays and will be used as the example application of the invention claimed here.

Characteristics associated with the example relay that are of interest to this invention are the magnetic and mechanical effects relevant to the design and construction of the relay. The principal consideration is controlling the velocity of the armature relative to the core. In the design of relays as depicted here, the armature is attracted to the core by the magnetic flux introduced into the core by the coil upon energization. This is not generally controlled. Rather, the maximum sustainable current is simply applied to the coil and the force applied to the armature is dictated by that static field. The resultant motion of the contacts is controlled by that force applied to the mass of the armature (including contacts) and the mechanical design of the armature and linkages which determine the leverage that force is applied through. Upon removal of electrical current, the field collapses and the attraction between the armature and the core no longer exists. The spring then pulls the armature away from the core and in turn changes the position of the movable contact with respect to the other contact(s). It should be noted that numerous contact arrangements are possible, but all contact arrangements depend on the position of the movable contact(s).

The method of driving the relay coil(s) described below allows the armature to be acted upon in a dynamic and controlled fashion that allows the motion of the armature to be optimized for the intended purpose. Adding an additional coil, or “splitting” the existing coil, allows for cost-effective manufacture of these general-purpose relays by existing means, but most importantly allows for a high degree of control over the motion of the armature. Note that in the examples that follow, two coils are shown, however as noted above, it is also possible and may be advantageous to use one coil with multiple windings. Also, it may be advantageous to use one or more cores and one or more windings in various configurations and geometries. By changing how the coil is arranged, and driving the coils from a controlled electronic source that can dynamically change the current in the coils, the motion of the armature can be accelerated nearly to its theoretical limits, and then de-accelerated just prior to the contacts landing to provide a soft landing, and hence minimize bounce.

This technique is something we call “Rocket Relay™” because the physics involved are similar to those involved in rockets. Bounce is the inevitable reaction of the two metallic surfaces of the contacts hitting each other at significant velocity and the various elastomeric and flexure elements interacting to produce two or more contact events to occur upon the landing cycle.

Resonance and mass, materials selected, and numerous other factors contribute to the bounce. A great deal of effort has been put into reducing the bounce via mechanical means and is not a focus of discussion here. The principal concept that this patent addresses is the ability to control the velocity and motion of the armature, and hence the movable contact, such that it can move from one position to the other with optimum speed and minimum bounce. In this example, it is done via control of the electromotive force. Controlling the electromotive force can be used to advantage in other electro-mechanical devices where accelerated, controlled motion(s) would be of benefit. Also note that other means could be also used to apply controlled forces to move the contacts in an accelerated, controlled fashion distinct from application of a simple force.

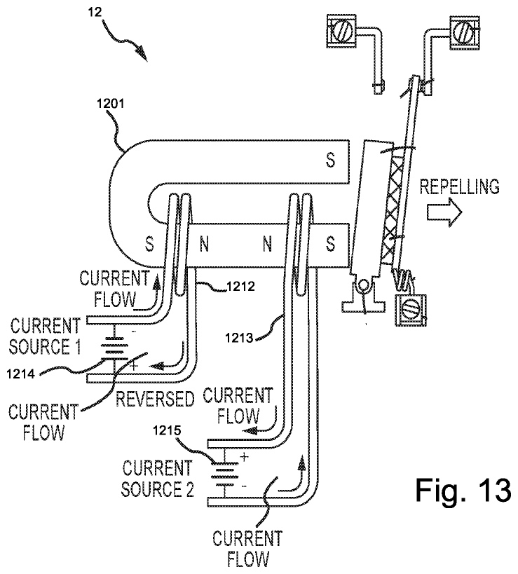

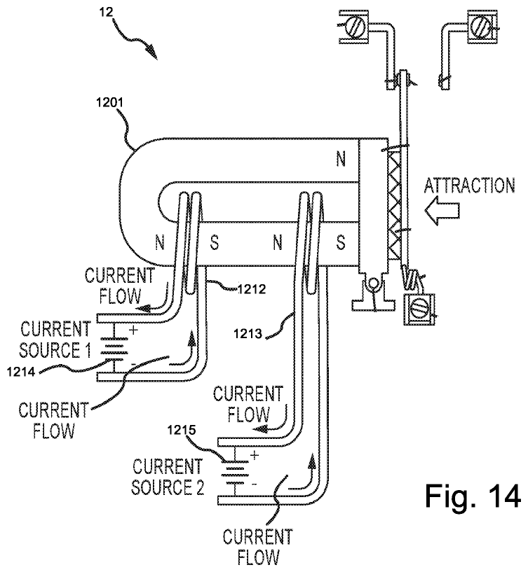

To achieve this dynamic capability, a means of applying a force in either direction on the armature is required. In this example the electromotive force can act to both pull the armature and repel it as required. The concept introduced here provides that capability utilizing the existing general mechanical construct of the example general purpose relays. FIG. 13 and FIG. 14 show how the invention can be incorporated into the relays described in FIG. 11 and FIG. 12.

The first example of the invention shown in FIG. 13 uses a relay (12) similar in construction to the generic relay mechanism described in FIG. 1, with the notable change of the addition of a second coil (1213) in addition to the original coil (1212), and the lack of a return spring and mounting point for that spring. In addition, an additional current source is shown as a battery (1215) delivering current to the second coil (1213) in one direction as shown. Simultaneously, current is being supplied to the other coil (1212) in the opposite direction.

This is a fundamental concept of the invention. This counter-delivery of current to two coils results in magnetic fields that oppose each other at the space between the coils, while simultaneously delivering a counter opposing force at each end of the core (201). This counter force causes flux to enter the armature at the pivot point nearest the core (201) and produce a strong repelling effect at the other end of the armature with respect to the field present there. Use of north N, and south S designations help to illustrate the effect. Much like trying to push two magnets of the same polarity orientation together, this field condition presented here causes the armature to be repelled, and the need for a return spring is eliminated. More important than the elimination of the spring, is the fact that bi-directional control of the armature is now possible from solely electronic means if desired.

FIG. 14 represents the same relay (2) now in what would be traditionally referred to as the energized condition. In this case, current to the second coil (1213) remains the same as in the complement case, but the current delivered to the first coil (1212) is now reversed from the preceding case by reversing the current from the source battery (1214). At this time, both coils are conducting current in the same direction and hence the two magnetic fields add together and result in opposite polarities of flux appearing at the ends of the core (1201). This state causes the armature (209) to be attracted towards the core (1201) and change the position of the contacts as described earlier.

The principal difference when actuating the relay in this mode is that as the armature nears completion of the transition from one position to the other, the current delivered to either coil (1212, 1213) can be rapidly reversed in one or more impulses or by a pre-specified amount to deliver exactly the amount of counter force needed to the armature as described in the previous state description of FIG. 13. This counter-force can be calibrated or controlled such that the armature is de-accelerated prior to contact of physical material of either the core or the contacts. Upon completing the motion, the contacts are in contact, and a small current can be maintained to either one or both of the coils (1212, 1213) as needed to hold the contacts in place.

The timing, amount and control of the electrical currents applied to the coils and resultant net force placed on the armature can be optimized to minimize the transfer time of the relay as is further detailed below or provide for any desired transfer time, e.g., in any application where a particular transfer time is desired, within practical limits, that transfer time can be “programmed” into the device by appropriate selection of values for the noted parameters. For certain critical equipment environments, such as transfer switches for EDP equipment, the contact gap is sufficient to avoid arcing in such environments and the transfer is sufficiently short that it can be tolerated by such equipment. For example, in the case of 120 v, 15 A power (e.g., in a U.S. data center), the contact gap may be at least 1.5 mm and the transfer time may be less than 20 milliseconds, for example, no more than about 8 milliseconds. The required gap will vary depending on the voltage and current that needs to be supported. For certain applications, such as relays to perform switching at zero crossings of the power signal (e.g., for cycle stealing), the transfer time is preferable much shorter than 8 milliseconds. It should be noted that the control of the timing and motion of the contacts can be used to optimize the durability of the relay. The motion of the contacts can be controlled so that they separate on or near a zero-voltage crossing (for AC current) which minimizes arcing damage to the contacts and land in a controlled fashion with minimum bounce on or near the next zero voltage crossing, which again minimizes arcing damage to the contacts. This technique sacrifices some transfer time speed for maximum durability, which may be worthwhile in some applications. Such a relay would outlast traditional relays due to minimum contact bounce and minimized contact arcing.

Various material and mechanical optimizations can be made to the relay utilizing this method of moving the armature. Although the methods described apply to relays constructed with traditional materials and components, with the resulting considerable improvement in performance (in this example transfer time, contact bounce and durability) the use of the dual coil drive allows additional refinements. Of particular note is the desire to reduce the mass of the moving component, the armature and the attached current carrying components. This allows higher acceleration and de-acceleration rates to be achieved, further reducing transfer times. The material the contact is constructed from can be selected to be a higher electrically conductive material, for example gold. Heretofore, contacts, if made of gold, although possessing much greater current carrying potential per unit mass, would deteriorate due to the mechanical stresses (and resulting deformations, since gold is a soft material, mechanically speaking) induced by uncontrolled landing of the contacts upon each other. With the dual coil method of driving the armature, the impact forces and resulting contact deformation are minimized, thus allowing the use of gold for the contact itself, thus enabling a reduction of the total moving mass.

The material the core and the armature are constructed of can also be improved. Using the ability to closely control the application of current to each of the coils means that much higher initial current levels can be applied, and counter-motion coil currents can also be of a much higher level than normally associated with traditional relays. In this regard, the total amount of flux density per unit mass can thus also be increased. To accomplish this, higher permeability metals such as Hypersill™ silicone iron, or other types of super alloys, even some types of ferrites can be utilized. Again, the characteristic of soft landing enables the use of a ferrite armature without concern for fracturing the brittle material when the armature closes on the core. The armature can be designed to utilize the best magnetic materials with much less concern for their mechanical properties and also profit by the fact that the relay can be designed to more uniformly apply the electromagnetic force to the entire armature (compare this to an armature that is actuated via a spring for example), again reducing the need for mechanical strength in the armature. The location, shape, and geometry of the: coils, magnetic core or cores (these examples show one core, multiple cores and/or specially shaped cores with one or more windings can be used to advantage), contacts and magnetic materials in the armature may also be optimized to produce the desired force upon the armature.

It may be possible to further optimize the armature by using very light materials, for example carbon fiber, in combination with controlled placement of suitable magnetic materials, to further reduce transfer times. An example of this technique would be an armature with ferrite elements that was then wrapped in carbon fiber to make an assembly. Other components could be incorporated, for example low-friction bushings on the pivots. In any case, the use of higher flux density materials in the core and the armature allow further reductions in the total moving mass by allowing them to have smaller cross section for the amount of magnetic attraction or repelling required. Conversely, a higher cost might be associated with the more permeable materials, but the cost would be small in comparison to the increase in performance. Acceleration of the armature is a function of the electromotive force that can be applied divided by the mass. Thus, if a higher electromotive force can be imposed because the material can sustain a higher flux density, for the same mass, the acceleration can be greater.

### Description of Operation and Electrical Current Supply

The relay modifications described here for improved performance depend on the ability to supply drive currents optimized to produce the desired improvements in relay performance, which also enable improvements in its mechanical properties for the desired applications. Since this design is dependent on having some electronic means to deliver those currents, the coils located inside of the relay can be optimized to perform with those circuits independent of the input drive voltage from the source that delivers the signal to the relay to change state. In a traditional relay, that source might be, as an example, a 24 Volt DC signal. When the 24 VDC is applied in a traditional relay, the coil becomes energized directly from the current available from that 24 volts, then the relay coil must sustain the magnetic force to hold it in the energized state as long as the supply of 24 VDC is present. Upon removing the 24 VDC, the traditional relay will simply lose magnetic field holding the armature in place, and the spring would supply the return force for the armature.

In the accelerated armature method, all of the coil energy is delivered to the armature, and none to the spring, since no spring is needed. Thus, an additional increase in performance is realized from this characteristic as well.

In addition, a coil of a traditional relay must have many turns of wire to provide sufficient resistance to not overheat the coil when in continuously actuated mode. The many turns of wire around the ferromagnetic core produce very significant levels of Inductance. Inductance in series with a high-speed transition from non-conducting to conducting is a limiting factor in how fast the ferromagnetic core, and armature can have a field build. Since one of the goals of this invention is to speed up the relay, e.g., reduce flight time, increasing the rate at which the magnetic field can build is desirable. To achieve this, the electrical characteristics of the coils in the accelerated armature relay should have reduced inductance. This is achieved by fewer turns of wire. As the number of turns of wire is reduced, so also is the inductance. Thus, faster capability to introduce magnetic flux is achieved.

Observing FIGS. 11 and 12, the traditional relay (11) has a coil (1112) of many turns. The coils drawn are representative, not literal, as the actual number of turns on a traditional coil often is many thousands of turns. However, observing FIGS. 13 and 14, the coils (1212, 1213) are shown having few turns. This also is representative, but the actual turns could be as few as 10 turns, possibly even less for low voltage relay configurations. This is because the capability to function with very short bursts of relatively high current will work with such low turn count coils, as it will not be there for more than the duration of the flight time of the armature. Then, either a low-steady state current or an occasional pulse is necessary to hold the relay in one state or another. When a pulse is used, the magnetic energy held in the ferromagnetic material sustains the attraction or repelling forces between those pulses.

The frequency, duration and amplitude of the pulses can vary quite a bit with the design and size of the relay, because these dictate how much magnetic energy the core(s) can hold. However, these variables will be chosen to ensure that the contacts are held in the desired state with at least a minimum desired pressure to insure proper contact function. This is another advantage to the accelerated armature design of this invention. Only the amount of power needed to hold the armature in place is required. Since no spring, or a minimal spring sufficient to hold the contacts together is present (a design option that eliminates the need for a steady state or pulsed current to hold the contacts together in one state (open or closed), the magnetic force needed to hold the relay in one or both states is optimized to be minimized, because it is not constantly working against the counterforce of a strong spring (designed to move the armature from one state to another in the desired timeframe in a traditional relay). Thus, the benefit is an overall reduction of power consumption in an actuated relay state.

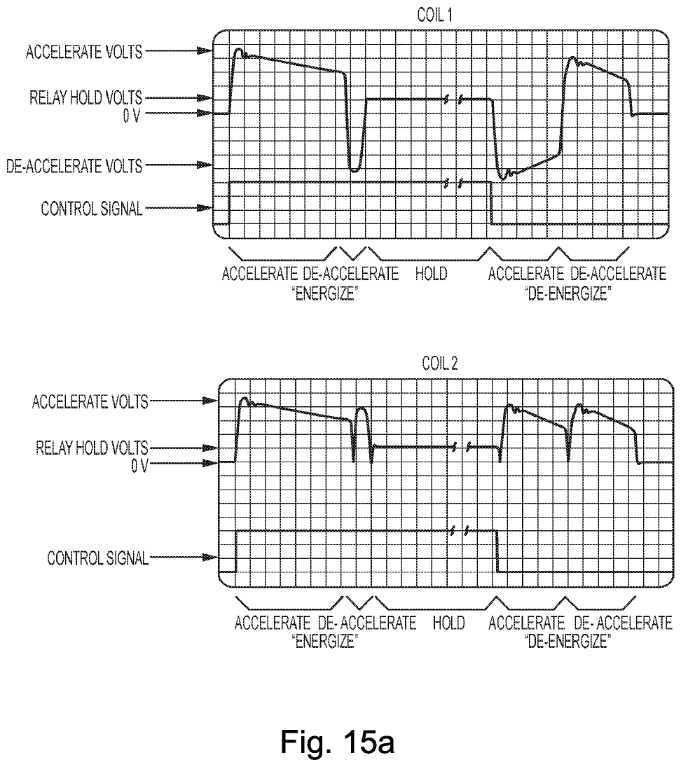

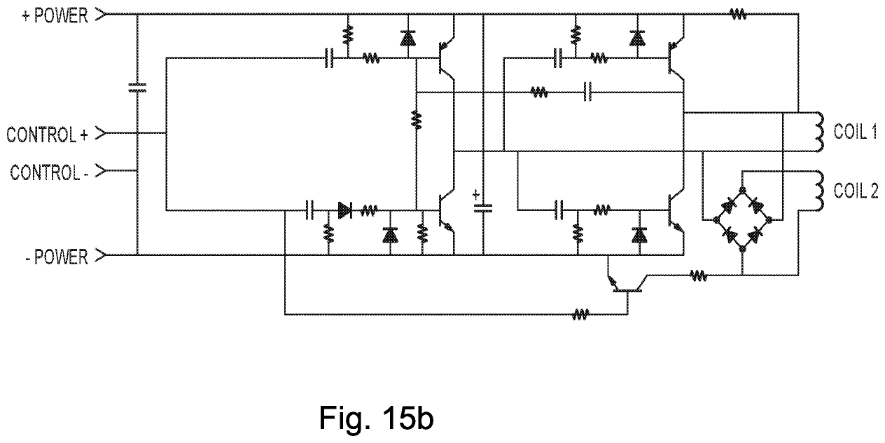

As described earlier, current must be supplied to at least one of the coils in a reversible fashion. It may also be pulsed, rather than continuous. Many methods are possible for supplying the current, most are traditional electronic design methods. The most direct approach is to have an analog based circuit that delivers a single pulse of sufficient voltage and current for each of the phases of the sequence for opening or closing the armature. FIG. 15a represents the basic necessary states of drive-in time/voltage (oscilloscope mode), hereafter referred to as synchogram, and a simple example driving circuit that could create this set of conditions in FIG. 5b.

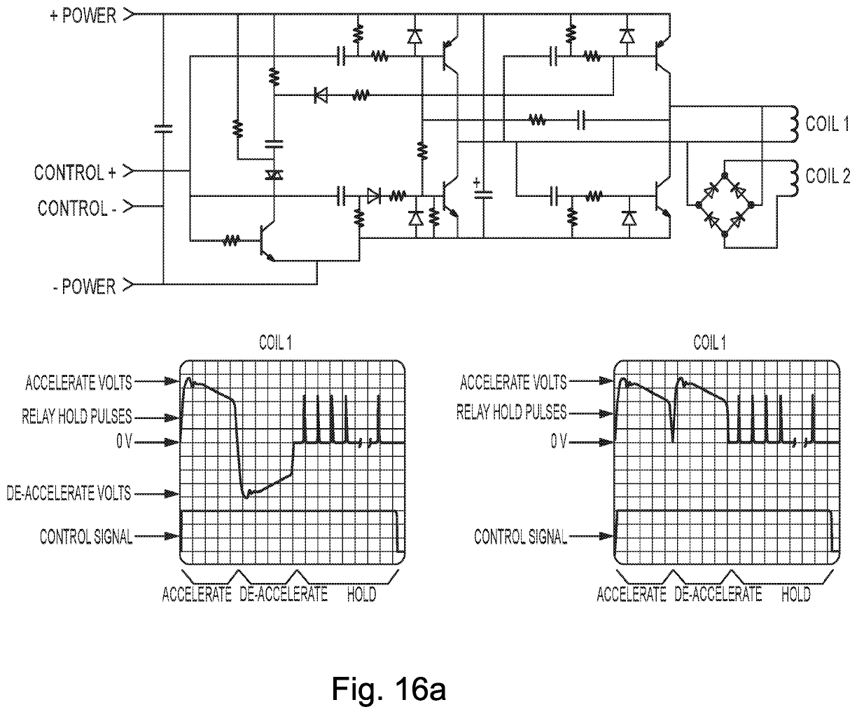

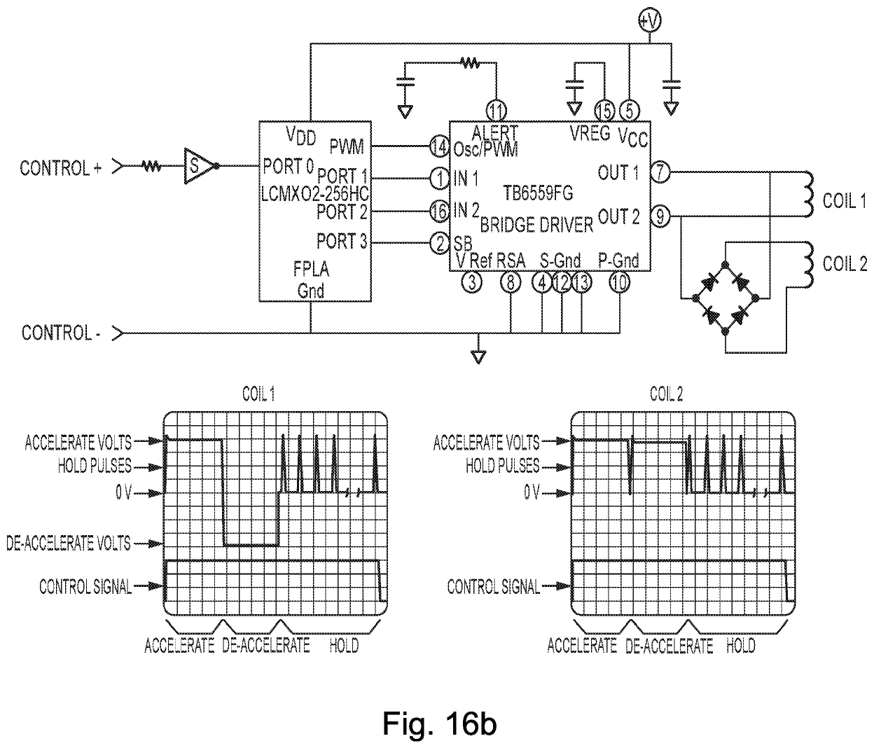

FIG. 15a shows a synchogram of the basic operation sequence associated with a full energize to de-energized cycle. At the beginning of the cycle, the control input signal changes state to the “energize relay” condition, either a voltage or current application, much the same as a traditional electro-mechanical relay would experience. At the initiating edge of the control signal, coil 1 and coil 2 are delivered a relatively high energy pulse that is in phase with each other that produces a strong attractive magnetic field to the armature. This initiates the acceleration stage during the energize portion of the cycle. After a short period, the armature is in motion and approaching the closure point with the contact and the core. Shortly before the contacts mate and the armature reaches the core, coil 1 is delivered another relatively high energy pulse that is now reversed in its field direction. This reverses the field polarity of coil 1, but because coil 2 is connected to the driver via a bridge rectifier, the coil 2 is delivered the same polarity as in the first stage of operation. The reversed field on coil 1 now forces the ends of the core to both experience same polarity of flux, thus strongly repelling the fast-approaching armature. Since at this time the armature is getting nearer and nearer to the core, the field density is increasing also, and a very short duration reverse polarity is needed to rapidly de-accelerate the armature. By tuning the amplitude and duration of this pulse, the armature, and more importantly the moving contact can be smoothly de-accelerated to zero velocity just as the moving contact touches the fixed NO contact. This will nearly eliminate any “bounce” of the contacts. The next stage of the drive is called “Hold”. Since the contacts are now touching, a current must be applied to the coil(s) to hold the contacts together securely. Since no springs are involved, a small current is applied to the coils to maintain the contact pressure. Either a small continuous current, or a series of very short pulses can be utilized to perform the hold function, as described earlier and shown by example in FIG. 16a.

After a period of time, it may become desirable to dis-engage the relay and have it return to the de-energized condition. Upon removing the control signal from the input the process of returning the armature to the NC position is initiated. Upon the falling edge of the control signal, the drive circuit now delivers a relatively high energy pulse of reverse polarity to coil 1, and normal polarity to coil 2. This results in a high common flux polarity, thus strongly repelling the armature. It accelerates away from the core to near midpoint, whereupon the coil 1 is reversed in its polarity. This needs to be done near midpoint, as the gap formed now between the armature and the core is now increased to a point where the relative flux coupling is decreasing exponentially, and thus the reversal of polarity must occur sooner than in the energize state in order to provide sufficient de-acceleration of the armature to allow the moving contact (attached to the armature) to de-accelerate to almost zero velocity at the time it touches the NC contact of the relay. In some configurations of relays, such as those without electrical contact in the Normally Open (NO) position, the early braking may not be necessary.

Upon completion of the de-acceleration stage, all currents fall to zero if no electrical contact is necessary in the de-energized condition, or a small current can be delivered at this time also to provide contact pressure if electrical connection through the contacts is desired.

FIG. 15b shows a possible configuration of electrical components for an all-analog drive circuit to accomplish the stages of operation described in FIG. 15a. A detailed description of the operation of this circuit is beyond the scope or intent of the invention, but is included to allow those familiar with the art to understand the characteristics of the waveforms shown on the synchogram in FIG. 15a.

FIG. 6a outlines an alternative analog drive circuit example that includes pulsed “Hold” current and the relevant synchogram.

In FIG. 16a, an electrical circuit in the driver consisting of a relaxation oscillator formed by a DIAC, and resistor-capacitor, routinely deliver a very short pulse of energy to the coils of the relay to perform the hold function as opposed to a low level constant current. The advantage of this driver design is higher efficiency, lower cost and ease of construction of the coils of the relay. Since all operations are now of very short duration (including the hold, it consists of pulses), the number of turns on the coils may be reduced to the lowest possible number required for insertion of the necessary flux for the duration of the longest pulses. This reduction of number of turns also reduces the Inductance of the coils, thus allowing faster field density changes.

FIG. 16b outlines an alternative possible digital drive circuit example that could be a more cost effective production solution due to the lower parts count, and greater timing and control functionality, including pulsed “Hold” current and asymmetrical accelerate and de-accelerate timing.

In FIG. 16b, the synchograms only represent the energization phase, and these are intended to show the similarity to the analog driver stages for the energize half of the complete cycle. A Field Programmable Logic Array (FPLA) is shown as the source of the signaling control for a Bridge Driver that amplifies the signals to drive the coils. Easily, a Programmable Gate Array (PGA) or even a simple microprocessor can be used for the signaling source. In fact, the relay signaling function could be supplied by a remote microprocessor, where the relay drive function is being controlled from in the first place, and the command operations could be a simple peripheral to that processor. Many configurations of how to derive the signaling function can be imagined and/or utilized. In one instantiation, many relays may be operated from one processor or logic array as is described in the “PARALLEL REDUNDANT POWER DISTRIBUTION” application referenced above.

The description of the invention applies as described in the examples given to a traditional general purpose hinged armature relay construction, but the basic concepts apply to numerous other construction types. The following lists some, but not all, alternative relay constructions that this invention can apply to:
1. Linear moving core relay, often described as a “contactor”.
2. Rotating cam, commonly used in miniature relays such as so-called “DIP” (dual inline pin, like an integrated circuit).
3. Full rotary, with ball-and ramp.

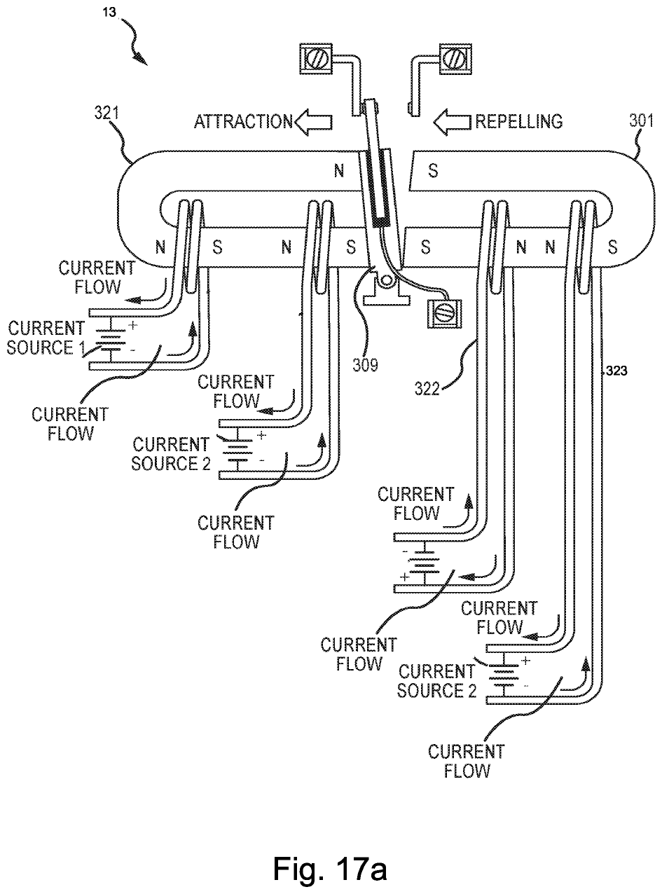

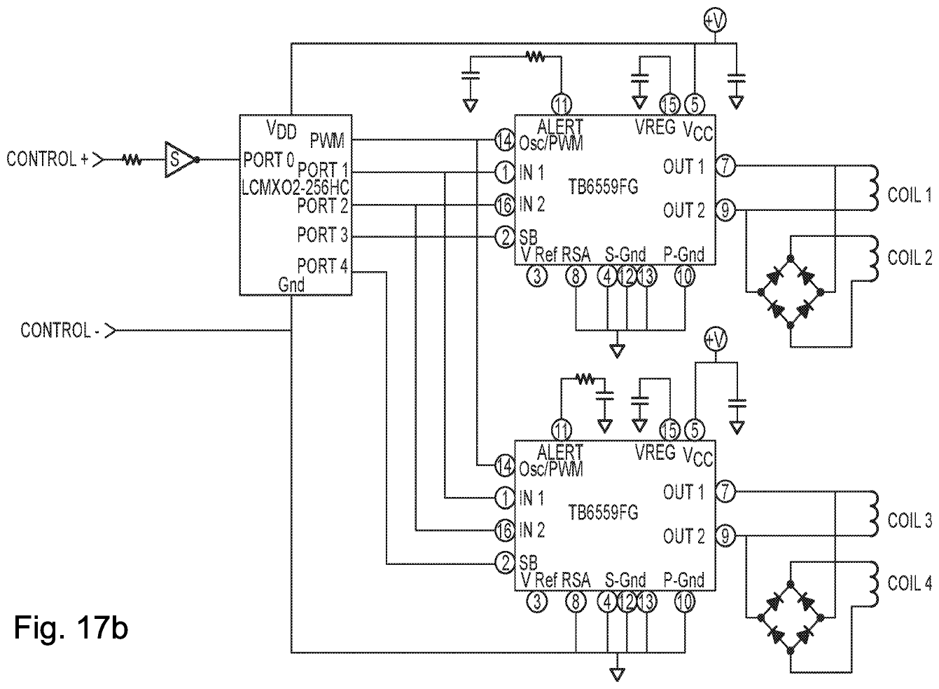

FIGS. 17a and 17b represent an alternative assembly of the general purpose relay. It is describing a dual core application utilizing two sets of drivers and dual coils for increasing the speed and improved armature motion control.

Observing FIG. 17a, another instantiation of the basic concept is demonstrated. A second core (301), and additional pair of coils (322, 323) has been added to the arrangement previously described, mirrored and placed bi-laterally. In addition, both cores (301, 321) have been angle cut on the mating face with the armature (309) to produce a symmetrical cavity for the armature to travel in. Slight repositioning of armature (309) sub-components such as the insulator and the electrical connections, contacts, etc., have been made to accommodate the bi-symmetrical configuration.

In this instantiation, the features of the dual coil accelerated armature can be further exemplified. With both sets of coils acting upon the armature, advantage can be taken of the initial acceleration of the armature (309) from either position via concentrated common pole flux lines. In the single core instantiation, only on the “energize” half of the cycle could initial acceleration benefit from the concentrated common pole flux lines. These could only be presented as the armature departs from the core, or as it returns, but not at the open phase. In this dual core instantiation, both acceleration, and de-acceleration can take advantage of compressed flux density.

This enables a longer acceleration pulse and shorter de-acceleration pulse, ultimately allowing higher mid-flight velocity. In addition, because as the armature is about to deliver the contacts at the same time it is nearing high flux density compression, the shape of the pulse at that moment can be modified to optimize contact landing, and hold pressure. It is likely that complex waveforms delivered to each of the four coils will be employed to optimize overall performance. This is easily accomplished using the digital control example circuit described in FIG. 17b, but with an additional Bridge Driver connected to the FPLA and the second set of coils.

### Solid State Relay

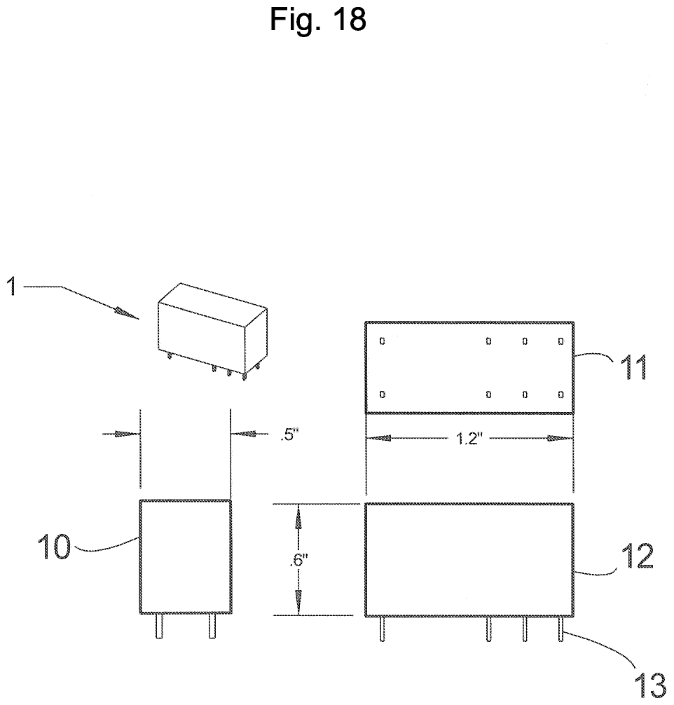

FIG. 18 depicts the mechanical outline of a traditional electro-mechanical relay of the example G2RL footprint. It should be noted that various footprints in this size category are possible, and this representation is not restricted to this exact combination of size and dimensions. Observing FIG. 18, the dimensions of the package can be observed and envisioned as miniature with respect to many available electro-mechanical relays on the market. The overall package size of 1.2 inch by 0.6 inch by 0.5 inch is in the reasonably compact category for power control relays. This package size is used extensively in industry, and in particular, in the system described in U.S. Pat. No. 8,004,115, issued on Aug. 23, 2011, entitled, “AUTOMATIC TRANSFER SWITCH MODULE.”

FIG. 18 depicts an orthogonal view (1801) of the referenced relay package with end view (1810), side view (1812), top view (1811), and a typical pin (1813), often in various combinations of placement on the bottom of the relay, but generally with a pitch of 0.2 inch with respect to other pins. The relay shown is of the Form C mentioned earlier. The relay depicted in FIG. 18 also has two sets of Form C contacts.

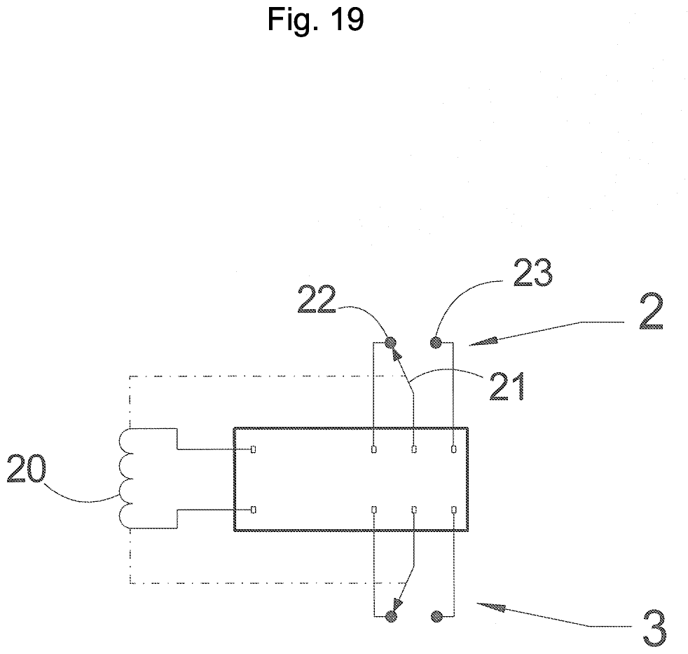

FIG. 19 shows the electrical configuration of this relay:

It shows one set of the Form C contacts (1902), with the parallel set (1903). The Common contact (1921), the Normally Closed (NC) contact (1922) and the Normally Open (NO) contact (1923). A coil (1920) is utilized to change the position of the two common contacts simultaneously.

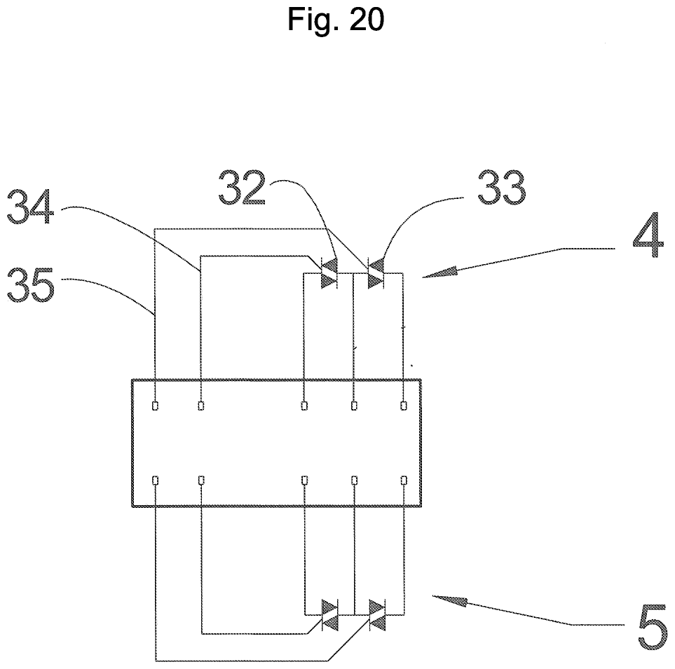

FIG. 20 depicts the same relay with the schematic representation of the Solid State Relay components. FIG. 20 shows a schematic representation of the desired configuration referenced in this invention with the four semiconductor Alternating Current (AC) control switches often called Triacs (2032, 2033), or Thyristors. These semiconductor devices essentially replace the contacts found in a traditional AC switching applications. In addition, the traditional coil is replaced with a control wire on each of the Triacs (2032, 2033) called a Gate. These Gates (2034, 2035) are now connected to pins on the bottom of the Relay assembly.

Switch pair (2004) is the equivalent to one of the Form C contacts mentioned in the traditional electro-mechanical relay, and switch pair (2005) is the equivalent of the second of the Form C contacts mentioned in the traditional electro-mechanical relay.

The principal limitation of the SSR is the heat generated. Solid State semiconductors including, but not limited to, triacs have a typical voltage drop across the two power conduction terminals of about 1.2 Volts. This means that when current is running through the semiconductor, the semiconductor is dissipating power at a rate of about the current times the voltage drop, or, in the example relay case of 6 Amps, 6 Amps times 1.2 Volts, or 7.2 Watts. This is not a great amount of heat, but in the confined space of the package dimensions of the desired embodiment of this patent, it is very difficult to dissipate. The example presented here allows an easily manufactured means of dissipating that heat, thus enabling the manufacture of the SSR in miniature form factors for universal replacement and use in place of the electro-mechanical varieties. This is desirable to enable faster actuation times, and better control of the timing of the admittance of current through the relay(s).

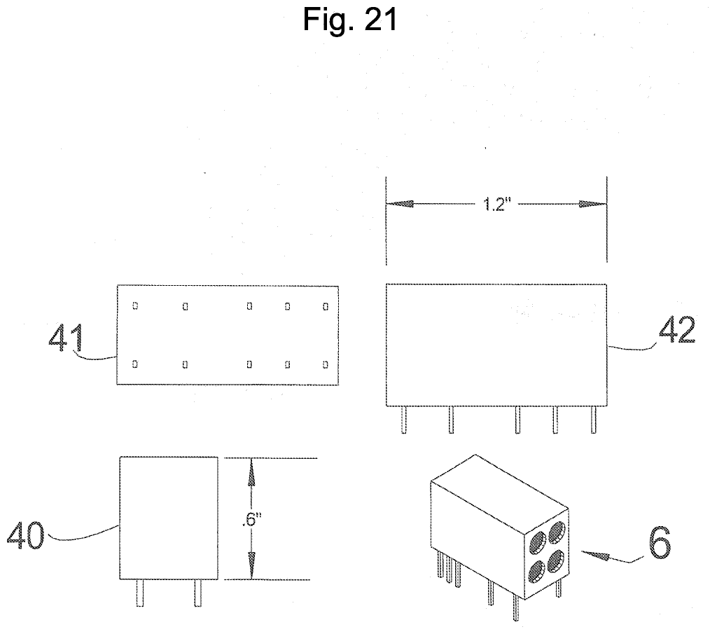

FIG. 21 depicts a mechanical layout cross section of a preferred embodiment of the invention:

In FIG. 21, it should be noted the overall mechanical dimensions of the package are the same as in the example provided for the miniature electro-mechanical equivalent. Of notable exception are two additional electrical mounting and conductors for the additional gate controls mentioned, and apertures at the ends of the relay (2106) to allow heat to be expelled via air circulation.

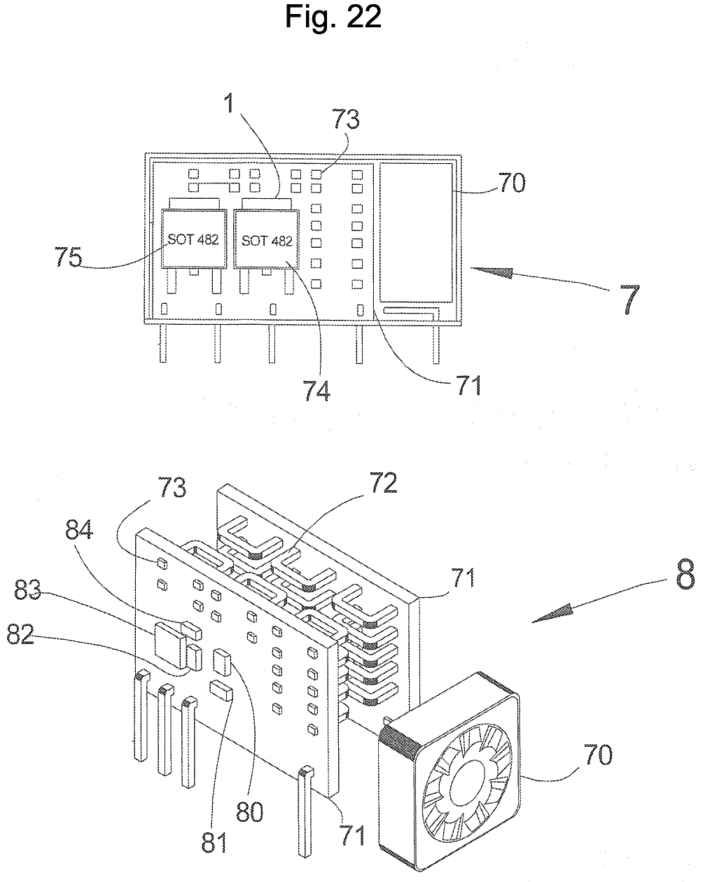

FIG. 22 depicts a cross section of the example relay discussed in accordance with this invention. It depicts the cross section (2207) and orthogonal (2208) views of a preferred embodiment of this invention. Observing the cross section the principal components of the SSR can be seen. As mentioned before, for each Form C switch equivalent, a pair of Solid-State devices (2274, 2275), such as triacs or thyristors, are used. The device package preferred for these Solid State devices is the JDEC SOT482 package style, although it is possible to use other equivalent or nearly equivalent size packages. Also shown is a critical component, a fan (2270). These sub-miniature fans are now commercially available in a package size of 10 mm by 8 mm by 3 mm, from various manufacturers. The ultra-miniature size of these mechanical fans allow the construction of this relay embodying the invention. Shown are copper “U” shaped jumpers (2272) in numerous locations with the tips (2273) of those jumpers (2272) shown protruding through the Printed Circuit Board (2271). The Solid-State Switches (SSS) (2274, 2275) are surface mounted soldered to the interior surfaces of the PCBs (2271) and have contiguous copper from under those SSS devices to the solder in points of the jumpers (2272). This copper trace is of a thickness selected to provide suitable heat transfer from the SSS devices (2274, 2275) to all of the jumpers (2272) It should be noted that each PCB shown has a total of 9 such jumpers (2272), but more or less could be utilized, as well as the placement of the components could be arranged for better PCB layout, or more efficient heat transfer. Air, circulated by the fan (2270) is drawn or pushed across all of the components (2274, 2275, 2280 to 2284, 2272) especially the jumpers (2272) to remove heat.

One aspect of the invention consists of the novel application of currently available standard jumpers used in the machine production of PCB assemblies. Sufficient surface area can be acquired for very efficient cooling of the SSS devices (2274, 2275) by simply inserting the desired number of jumpers in various locations and possibly at various depths. The depth of insertion is a programmable item with modern automated assembly machines. Thus, the completed sub-assembly consisting of a PCB (2271), electronic components (2274, 2275, 2280 to 2284) and multiple copies of heat sinking jumpers (2272) can be accomplished in a single pass on an automated PCB assembly machine, a process often called “stuffing”.

The final assembled relay can be covered by an injection molded cover or left exposed without a cover for use in arrangements where the fan (2270) is either replaced by, or supplemented with external cooling air moved by an external source.

Additional electronic components (2280 to 2284) are shown for a possible option that allows electronic control for the gate drive of the SSS devices (2274, 2275) such that only switching at the point where the applied AC voltage passes through zero volts on each half cycle. This so-called zero crossing control may be utilized to provide more contiguous and non-harmonic switching. An additional benefit, and possibly requirement will be that at no time can both SSS devices be turned on simultaneously. The additional electronic components (2280 to 2284) are also capable of being arranged in a manner that prevents this occurrence.

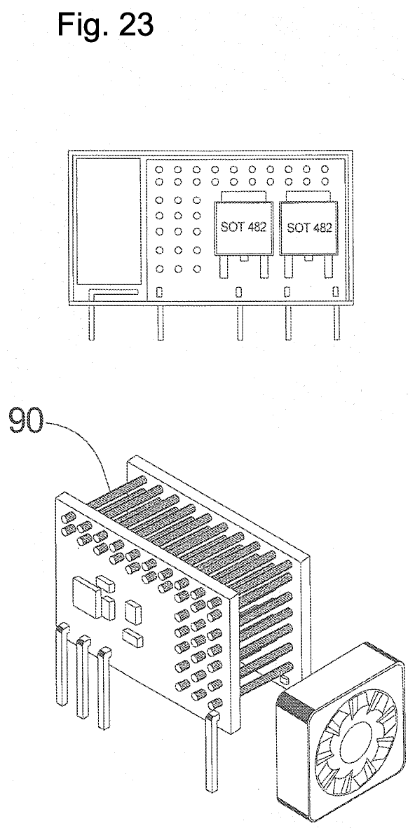

FIG. 23 depicts an alternate instantiation of the heat sinking jumpers. In FIG. 6, it can be observed that the jumpers referenced in FIG. 5 (72) have been replaced by jumpers (2390) proceeding between the two main boards. This variation could be applied for applications where the electrical components of each of the two SSR semiconductor groups have common electrical potentials. This application could be utilized to construct a single Form C relay with double the current carrying capacity by sharing the current among two SSS devices, one of which is located on each of the board subassemblies. This configuration also utilized wire jumpers machine insertable, and does not require special heat sink sub-assemblies. In addition, the density of wire jumpers (preferably copper or aluminum), the placement of, and total number of can be selected to provide optimum heat transfer from the SSS devices to the air.

It should be noted that both the “U” shaped jumpers and straight jumpers described can have kinks, and other geometric variations to assist in improving their heat transfer efficiency.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed:

1. An electrical switch, comprising:
switch device, wherein an electrical circuit is closed when said switch device is in a first state and said circuit is opened when said switch device is in a second state; and
a control system for controlling operation of said switch device so that cycling of said switch device between said first and second states is synchronized with a phase of said power signal.

2. The electrical switch of claim 1, wherein said switch device comprises a switch mechanism for moving at least one of first and second electrodes between first and second positions corresponding to said first and second states, and wherein said first electrode is mounted on a piston for reciprocal motion within a piston housing, said switch further comprising a motor for driving said reciprocal motion of said piston within said piston housing.

3. The electrical switch as set forth in claim 2, wherein said piston housing comprises a cylinder.

4. The electrical switch as set forth in claim 2, wherein said motor comprises a magnet connected to said piston housing and a coil connected to said piston, wherein an electrical signal applied to said coil causes motion of said piston with respect to said piston housing due to interaction of said coil and magnet.

5. The electrical switch as set forth in claim 4, wherein said second electrode is mounted on said piston housing.

6. The electrical switch as set forth claim 4, wherein said electrical signal applied to said coil is coordinated with a power signal of said circuit such that operation of the electrical switch is synchronized with said power signal.

7. The electrical switch as set forth in claim 6, wherein said one of said connection between said first and second electrodes and said disconnection between said first and second electrodes is synchronized with a zero crossing of said power signal.

8. The electrical switch as set forth in claim 1, wherein said switch device comprises a switch mechanism for forcing a conductive fluid into a space between first and second electrodes to establish an electrical connection and for withdrawing said conductive fluid from said space between said first and second electrodes to break said electrical connection.

9. The electrical switch as set forth in claim 8, wherein said switch device comprises a reservoir of said conductive fluid and a movable diaphragm for moving said conductive fluid into and out of said reservoir.

10. A method for operating an electrical switch, comprising:
providing a switch device wherein an electrical circuit is closed when said switch device is in a first state and said circuit is opened when said switch device is in a second state; and
operating a control system for controlling operation of said switch device so that cycling of said switch device between said first and second states is synchronized with a phase of said power signal.

11. The method of claim 10, wherein said switch device comprises a switch mechanism for moving at least one of first and second electrodes between first and second positions corresponding to said first and second states, and wherein said first electrode is mounted on a piston for reciprocal motion within a piston housing, said method further comprising operating a motor for driving said reciprocal motion of said piston within said piston housing.

12. The method as set forth in claim 11, wherein said motor comprises a magnet connected to said piston housing and a coil connected to said piston and said first operating comprises applying an electrical signal to said coil to cause motion of said piston with respect to said piston housing due to interaction of said coil and magnet.

13. The method as set forth claim 12, wherein said operating comprises applying said electrical signal to said coil in coordination with a power signal of said circuit such that operation of the electrical switch is synchronized with said power signal.

14. The method as set forth in claim 10, wherein said one of said connection between said first and second electrodes and said disconnection between said first and second electrodes is synchronized with a zero crossing of said power signal.

15. The method as set forth in claim 10, wherein said cycling of said switch device comprises forcing a conductive fluid into a space between first and second electrodes to establish said electrical connection and for withdrawing said conductive fluid from said space between said first and second electrodes to break said electrical connection.

16. The method as set forth in claim 15, wherein said switch device comprises a reservoir of said conductive fluid and a movable diaphragm and said second operating comprises moving said conductive fluid into and out of said reservoir.

17. The electrical switch as set forth in claim 1, wherein said switch device comprises a solid-state switch.

18. The method of claim 10 wherein said switch device comprises a solid-state switch.
